(19) United States
(12) Patent Application Publication
(10) Pub. No.: US 2018/0199215 A1
(43) Pub. Date: Jul. 12, 2018

(54) FILTERING EXTENDED RANGE FRAMES BY HIGH EFFICIENCY WIRELESS (HEW) STATIONS

(71) Applicant: QUALCOMM Incorporated, San Diego, CA (US)

(72) Inventors: Abhishek Pramod Patil, San Diego, CA (US); Alfred Asterjadhi, San Diego, CA (US); Alireza Raissinia, Monte Sereno, CA (US); Ravi Gidvani, Fremont, CA (US); George Cherian, San Diego, CA (US); Jeffrey Louis Smith, San Jose, CA (US)

(21) Appl. No.: 15/860,030

(22) Filed: Jan. 2, 2018

Related U.S. Application Data
(60) Provisional application No. 62/445,598, filed on Jan. 12, 2017.

(51) Int. Cl. H04W 24/02; H04W 52/02

(52) U.S. Cl. CPC H04W 24/02; H04W 84/12; H04W 52/0225

(57) ABSTRACT

This disclosure provides systems, methods and apparatuses for selectively acquiring communication frames from a transmitting device capable of formatting the communication frames in accordance with a plurality of PHY formats. In some implementations, a STA may filter or discard duplicate frames received from an AP based, at least in part, on a preference of the STA for one of the plurality of PHY formats. The filtering may be performed at the PHY, without forwarding received communication frames to the media access control layer (MAC) for further processing. In some other implementations, an AP may refrain from sending duplicate frames to a STA based, at least in part, on a preferred frame format of the STA. Still further, in some implementations, the STA may dynamically adjust or update its preferred frame format based on changes in the distance, or channel conditions, between the STA and the AP.

### CROSS-REFERENCE TO RELATED APPLICATIONS

This patent application claims priority to U.S. Provisional Patent Application No. 62/445,598 entitled “FILTERING EXTENDED RANGE FRAMES BY HIGH EFFICIENCY WIRELESS STATIONS” filed on Jan. 12, 2017 and assigned to the assignee hereof. The disclosure of the prior application is considered part of and is incorporated by reference in this patent application.

### TECHNICAL FIELD

The present implementations relate generally to wireless networks, and specifically to filtering of extended range frames by high efficiency wireless stations.

### DESCRIPTION OF THE RELATED TECHNOLOGY

A wireless local area network (WLAN) may be formed by one or more access points (APs) that provide a shared wireless communication medium for use by a number of client devices or stations (STAs). Each AP, which may correspond to a Basic Service Set (BSS), periodically broadcasts beacon frames to enable any STAs within wireless range of the AP to establish and maintain a communication link with the WLAN. As a STA moves through a given environment, the quality of communications with an associated AP may fluctuate. For example, the perceived signal quality of the WLAN may degrade as the STA moves further away from the associated AP. This may result in reduced throughput or termination of the communication link.

In some configurations, an AP may communicate with one or more STAs using multiple frame formats. For example, the IEEE 802.11ax specification describes an “extended range” (ER) frame format that allows the AP to communicate with STAs over an extended range (such as beyond a standard or conventional wireless range of the AP). A high efficiency (HE) AP operating in a dual beacon configuration may periodically broadcast beacons in both a legacy format and an ER format. As a result, HE STAs that are relatively close in proximity to the HE AP (such as within the standard wireless range) may receive duplicate beacon frames. This may cause such HE STAs to consume unnecessary amounts of time and resources in processing duplicate information from communication frames received in both the legacy and ER formats. Thus, it may be desirable to filter duplicate frames received by an HE STA.

### SUMMARY

The systems, methods and devices of this disclosure each have several innovative aspects, no single one of which is solely responsible for the desirable attributes disclosed herein.

One innovative aspect of the subject matter of this disclosure can be implemented in a method of selectively acquiring communication frames from a transmitting device based on a preferred frame format of the receiving device. The method may include steps of determining that the transmitting device is capable of formatting communication frames in accordance with a plurality of physical layer (PHY) formats, selecting one of the plurality of PHY formats as a preferred frame format for a wireless device, and selectively acquiring a first communication frame, from the transmitting device, based at least in part on the preferred frame format of the wireless device. For example, at least one of the plurality of PHY formats may be an extended range (ER) format.

In some implementations, the step of selecting one of the plurality of PHY formats as the preferred frame format may further include a step of selecting one of the plurality of PHY formats as the preferred frame format based at least in part on a proximity of the wireless device to the transmitting device. In some other implementations, the step of selecting one of the plurality of PHY formats as the preferred frame format may further include a step of selecting one of the plurality of PHY formats as the preferred frame format based at least in part on one or more channel conditions of a wireless channel between the wireless device and the transmitting device.

In some implementations, the step of selectively acquiring a first communication frame from the transmitting device may further include steps of receiving the first communication frame at a PHY of the wireless device and selectively forwarding the first communication frame from the PHY to a media access control layer (MAC) based at least in part on whether the first communication frame is formatted in accordance with the preferred frame format. In some aspects, the step of selectively forwarding the first communication frame from the PHY to the MAC may include a step of forwarding the first communication frame from the PHY to the MAC only when the first communication frame is formatted in accordance with the preferred frame format.

In some implementations, the method may further include a step of determining, at the PHY, whether the first communication frame is at least one of a broadcast frame or a multicast frame. In some other aspects, the first communication frame may be determined to be at least one of a broadcast frame or a multicast frame when a PHY header of the first communication frame indicates a transmit opportunity (TXOP) duration of zero. In some other aspects, the first communication frame may be determined to be at least one of a broadcast frame or a multicast frame when a PHY header of the first communication frame indicates a downlink transmission from the transmitting device and includes a basic service set (BSS) color value of zero. Still further, in some aspects, the first communication frame may be determined to be at least one of a broadcast frame or a multicast frame when a PHY header of the first communication frame includes a unique address associated with multiple recipients.

In some implementations, the step of selectively forwarding the first communication frame from the PHY to the MAC may further include a step of discarding the first communication frame, at the PHY, when the first communication frame is at least one of a broadcast frame or a multicast frame and is not formatted in accordance with the preferred frame format. In some other implementations, the method may further include a step of entering a power save mode for a duration of the first communication frame when the first communication frame is neither a broadcast frame nor a multicast frame and is not formatted in accordance with the preferred frame format.

In some implementations, the step of selectively forwarding the first communication frame from the PHY to the MAC may further include a step of transmitting, to the transmitting device, a second communication frame indicating the preferred frame format of the wireless device. In some aspects, the indication may be provided in at least one of a high efficiency (HE) capabilities element, an HE operation element, or an operating mode indication (OMI) element of the second communication frame.

Another innovative aspect of the subject matter described in this disclosure can be implemented in a wireless device (such as a STA). The wireless device includes one or more processors and a memory storing instructions that, when executed by the one or more processors, cause the wireless device to determine that the transmitting device is capable of formatting communication frames in accordance with a plurality of PHY formats, select one of the plurality of PHY formats as a preferred frame format for a wireless device, and selectively acquire a first communication frame, from the transmitting device, based at least in part on the preferred frame format of the wireless device. For example, at least one of the plurality of PHY formats may be an ER format.

In some implementations, execution of the instructions for selecting one of the plurality of PHY formats as the preferred frame format may cause the wireless device to select one of the plurality of PHY formats as the preferred frame format based at least in part on a proximity of the wireless device to the transmitting device. In some other implementations, execution of the instructions for selecting one of the plurality of PHY formats as the preferred frame format may cause the wireless device to select one of the plurality of PHY formats as the preferred frame format based at least in part on one or more channel conditions of a wireless channel between the wireless device and the transmitting device.

In some implementations, execution of the instructions for selectively acquiring a first communication frame from the transmitting device may cause the wireless device to receive the first communication frame at a PHY of the wireless device and selectively forward the first communication frame from the PHY to a MAC based at least in part on whether the first communication frame is formatted in accordance with the preferred frame format. In some aspects, execution of the instructions for selectively forwarding the first communication frame from the PHY to the MAC may cause the wireless device to forward the first communication frame from the PHY to the MAC only when the first communication frame is formatted in accordance with the preferred frame format.

In some implementations, execution of the instructions may further cause the wireless device to determine, at the PHY, whether the first communication frame is at least one of a broadcast frame or a multicast frame. In some other aspects, the first communication frame may be determined to be at least one of a broadcast frame or a multicast frame when a PHY header of the first communication frame indicates a TXOP duration of zero. In some other aspects, the first communication frame may be determined to be at least one of a broadcast frame or a multicast frame when a PHY header of the first communication frame indicates a downlink transmission from the transmitting device and includes a BSS color value of zero. Still further, in some aspects, the first communication frame may be determined to be at least one of a broadcast frame or a multicast frame when a PHY header of the first communication frame includes a unique address associated with multiple recipients.

In some implementations, execution of the instructions for selectively forwarding the first communication frame from the PHY to the MAC may cause the wireless device to discard the first communication frame, at the PHY, when the first communication frame is at least one of a broadcast frame or a multicast frame and is not formatted in accordance with the preferred frame format. In some other implementations, execution of the instructions may further cause the wireless device to enter a power save mode for a duration of the first communication frame when the first communication frame is neither a broadcast frame nor a multicast frame and is not formatted in accordance with the preferred frame format.

In some implementations, execution of the instructions for selectively forwarding the first communication frame from the PHY to the MAC may cause the wireless device to transmit, to the transmitting device, a second communication frame indicating the preferred frame format of the wireless device. In some aspects, the indication may be provided in at least one of an HE capabilities element, an HE operation element, or an OMI element of the second communication frame.

Another innovative aspect of the subject matter described in this disclosure can be implemented in a method of transmitting communication frames in accordance with multiple PHY formats. The method may include steps of generating a first management frame for a first basic service set (BSS) configured for a first PHY format, generating a second management frame for a second BSS configured for a second PHY format, where the second management frame includes a neighbor report identifying the first BSS as being co-located with the second BSS, transmitting the first management frame, in the first PHY format, on behalf of the first BSS, and transmitting the second management frame, in the second PHY format, on behalf of the second BSS. For example, at least one of the first or second PHY formats may be an ER format.

In some implementations, the neighbor report may further indicate the PHY format of the first BSS. In some other implementations, the first management frame also may include a neighbor report identifying the second BSS as being co-located with the first BSS. In some implementations, the method may further include a step of receiving a reassociation request, from a STA associated with the second BSS, to reassociate with the first BSS. In some aspects, the reassociation request may be based at least in part on a preferred frame format of the STA.

Another innovative aspect of the subject matter described in this disclosure can be implemented in a wireless device (such as an AP). The wireless device includes one or more processors and a memory storing instructions that, when executed by the one or more processors, cause the wireless device to generate a first management frame for a first basic service set (BSS) configured for a first PHY format, generate a second management frame for a second BSS configured for a second PHY format, where the second management frame includes a neighbor report identifying the first BSS as being co-located with the second BSS, transmit the first management frame, in the first PHY format, on behalf of the first BSS, and transmit the second management frame, in the second PHY format, on behalf of the second BSS. For example, at least one of the first or second PHY formats may be an ER format.

In some implementations, the neighbor report may further indicate the PHY format of the first BSS. In some other implementations, the first management frame also may include a neighbor report identifying the second BSS as being co-located with the first BSS. In some implementations, execution of the instructions may further cause the wireless device to receive a reassociation request, from a STA associated with the second BSS, to reassociate with the first BSS. In some aspects, the reassociation request may be based at least in part on a preferred frame format of the STA.

### BRIEF DESCRIPTION OF THE DRAWINGS

FIG. 1 shows a block diagram of a wireless system.

FIG. 2 shows an example HE Operation element.

FIG. 3 shows an example wireless system capable of supporting multiple PHY formats.

FIG. 4 shows an example HE SIG-A field of a PHY header.

FIG. 5 shows a timing diagram depicting an example operation for filtering communication frames based on a preferred frame format.

FIG. 6 shows an example wireless system capable of supporting multiple PHY formats.

FIGS. 7A and 7B show a timing diagrams depicting example operations for dynamically changing the preferred frame format for an HE STA.

FIGS. 8A and 8B show another example wireless system capable of supporting multiple PHY formats.

FIG. 9 shows a block diagram of an example wireless station.

FIG. 10 shows a block diagram of an example access point.

FIG. 11 shows a flowchart depicting an example operation for selectively acquiring communication frames in a preferred frame format.

FIG. 12 shows a flowchart depicting an example operation for filtering incoming communication frames based on a preferred frame format.

FIG. 13 shows a flowchart depicting an example operation for transmitting communication frames in accordance with a preferred frame format of a receiving device.

FIG. 14 shows a flowchart depicting an example operation for transmitting communication frames in accordance with multiple PHY formats.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving RF signals according to any of the IEEE 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM or General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

As described above, an AP may be capable of communicating with a STA using multiple PHY formats. For example, the IEEE 802.11ax specification describes an extended range (ER) frame format that allows a high efficiency (HE) access point (AP) to communicate with stations (STAs) over an extended range (such as beyond a standard or conventional wireless range of the AP). As a result, HE STAs that are relatively close in proximity to the HE AP (such as within the standard wireless range) may receive duplicate information that is transmitted by the HE AP in ER and non-ER frame formats. Thus, the implementations described herein may enable a STA to filter or discard duplicate frames received from an AP based, at least in part, on a preference of the STA for a particular PHY format. In some implementations, an AP may refrain from sending duplicate frames to a STA based, at least in part, on a preferred frame format of the STA. The preferred frame format for a particular STA may vary or change over time based on movements of the STA or changing channel conditions. Thus, in accordance with some implementations, the STA may dynamically adjust or update its preferred frame format based on changes in the channel conditions or the proximity of the STA to the AP. Aspects of the disclosure may be implemented at a physical layer (PHY) so that duplicate communication frames may be quickly identified and discarded, for example, without being forwarded to a media access control layer (MAC).

Particular implementations of the subject matter described in this disclosure can be implemented to realize one or more of the following potential advantages. The implementations may improve the performance of wireless devices configured for multiple frame formats. For example, by selectively filtering duplicate frames received from an AP, a STA may reduce its power consumption and the amount of time it spends in an active or awake state. Similarly, by selectively transmitting communication frames to a particular STA using a preferred frame format, an AP also may reduce its power consumption and the amount of time it spends servicing one particular STA. Furthermore, the implementations may allow a STA to receive communication frames in the most suitable format (such as the ER frame format or a non-ER frame format) based on the channel conditions or a proximity of the STA to an AP. For example, the STA may receive communication frames at a higher rate (in a non-ER frame format) when the STA is within a standard wireless range of the AP, while still being able to receive communication frames (in an ER frame format) when the STA is beyond the standard wireless range of the AP.

In the following description, numerous specific details are set forth such as examples of specific components, circuits, and processes to provide a thorough understanding of the present disclosure. The term “HE” may refer to a high efficiency frame format or protocol that may provide improved signaling capabilities over previous (“legacy”) protocols. Thus, the term “HE STA” may refer to a STA that is capable of implementing one or more HE frame formats or protocols. Similarly, the term “HE AP” may refer to an AP that is capable of implementing one or more HE frame formats or protocols. The IEEE 802.11ax specification defines a set of HE protocols that include, for example, an extended range (ER) frame format that may be used to extend the wireless range of HE-capable devices. Thus, the term “ER frame” may refer to a communication frame that is formatted for communications over greater distances (such as beyond a standard or conventional range of wireless communications provided by legacy IEEE 802.11 protocols). Similarly, the term “non-ER frame” may refer to a communication frame that is formatted in any of the various other HE or legacy frame formats (which does not include the ER format).

The term “PHY format” may refer to a particular formatting of a communication frame that is implemented in the physical layer (PHY). Thus, the terms “PHY format” and “frame format” may be used herein interchangeably. For example, ER frames and non-ER frames may have different PHY formats. More specifically, an ER frame may be formatted differently than a non-ER frame at the PHY layer of a transmitting device. Similarly, an ER frame may be interpreted differently than a non-ER frame at the PHY layer of a receiving device. In addition, although described herein in terms of exchanging data frames between wireless devices, the implementations may be applied to the exchange of any data unit, packet, or frame between wireless devices. Thus, the term “frame” may include any frame, packet, or data unit such as, for example, protocol data units (PDUs), MAC protocol data units (MPDUs), and physical layer convergence procedure protocol data units (PPDUs).

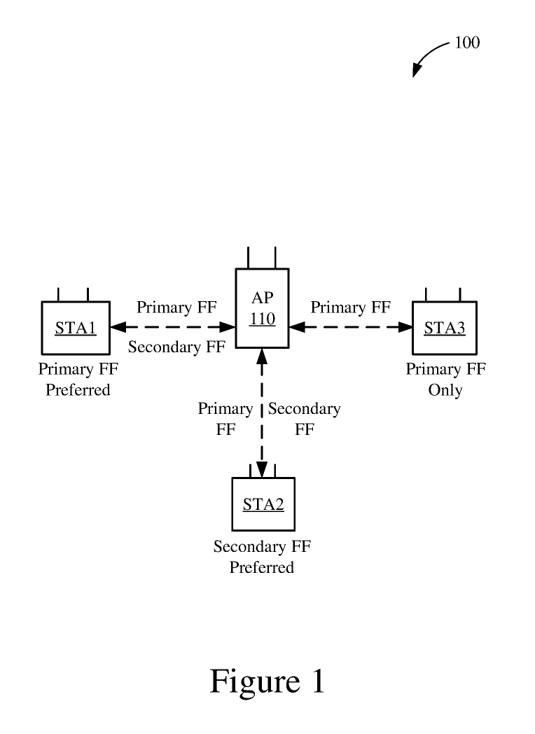

FIG. 1 shows a block diagram of a wireless system 100. The wireless system 100 is shown to include an access point (AP) 110 and a number of wireless stations STA1-STA3. Although only three wireless station STA1-STA3 are shown in the example of FIG. 1 for simplicity, it is to be understood that the wireless system 100 may include any number of STAs.

The wireless stations STA1-STA3 may include any suitable Wi-Fi enabled wireless device including, for example, a cell phone, personal digital assistant (PDA), tablet device, laptop computer, or the like. The AP 110 may be any suitable device that allows one or more wireless devices to connect to a network (such as a local area network (LAN), wide area network (WAN), metropolitan area network (MAN), or the Internet) using Wi-Fi, Bluetooth, or any other suitable wireless communication standards. In some implementations, the AP 110 may be any suitable wireless device (such as a wireless STA) acting as a software-enabled access point (“SoftAP”). The AP 110 and stations STA1-STA3 may each include one or more transceivers, one or more processing resources (such as processors or ASICs), one or more memory resources, and a power source.

In some implementations, the AP 110 may be capable of implementing multiple frame formats. Specifically, the AP 110 may be configured to format outgoing communication frames in accordance with a primary frame format (FF) and a secondary frame format. The primary frame format may perform better than the secondary frame format in certain environments or channel conditions, whereas the secondary frame format may perform better than the primary frame format in other environments or channel conditions. For example, in some implementations, the primary frame format may be generally associated with a higher signaling rate than the secondary frame format. On the other hand, the lower signaling rate of the secondary frame format may enable the secondary frame format to be used for communications over greater distances than the primary frame format.

The stations STA1 and STA2 may be capable of receiving communication frames in either of the primary or secondary frame formats. Based on channel conditions or a proximity of the AP 110 to STA1, communication frames transmitted by the AP 110 to STA1 may perform better when formatted in accordance with the primary frame format (as opposed to the secondary frame format). In other words, STA1 may “prefer” the primary frame format over the secondary frame format. On the other hand, based on channel conditions or a proximity of the AP 110 to STA2, communication frames transmitted by the AP 110 to STA2 may perform better when formatted in accordance with the secondary frame format. Accordingly, STA2 may prefer the secondary frame format over the primary frame format.

Although the AP 110 and each of the stations STA1 and STA2 is capable of implementing multiple frame formats, STA3 may be capable of receiving communication frames in the primary frame format only. To ensure support for each of the stations STA1-STA3, the AP 110 may transmit communication frames in each of the primary frame format and the secondary frame format. In some implementations, the AP 110 may transmit the same information, to one or more of the stations STA1-STA3, using a communication frame formatted in accordance with the primary frame format, and again using a communication frame formatted in accordance with the secondary frame format. For example, in some instances, the information may be addressed to the group of stations STA1-STA3 (as a broadcast or multicast frame). In other instances, the AP 110 may be unaware of the preferred frame format of each of the stations STA1 and STA2. As a result, stations STA1 and STA2 may receive duplicate information via multiple communication frames (herein referred to as “duplicate frames”).

A STA may avoid receiving duplicate frames by not associating with any APs that are configured to transmit communication frames in the non-preferred format. However, this may depend on the availability of a suitable AP, within wireless range of the STA, that is configured to transmit communication frames in its preferred format only. Furthermore, the preferred frame format for a STA may change over time. For example, while a STA may prefer the primary frame format under certain conditions (such as when the STA is within a threshold proximity of an associated AP or under relatively good channel conditions), the STA may prefer the secondary frame format under a different set of conditions (such as when the STA is beyond the threshold proximity of the associated AP or under relatively poor channel conditions). Thus, the preferred frame format for a particular STA may change over time, for example, based on movements of the STA or changing channel conditions. In some instances, the STA may lose its connection to the associated AP if it is unable to receive communication frames in the newly-preferred frame format.

It is noted that different frame formats may perform better than others under different channel conditions or distances between wireless devices. For example, the ER frame format (included in the IEEE 802.11ax specification) is a particular PHY format that may allow wireless devices to communicate more effectively over greater distances than legacy or non-ER frame formats. The ER format may offer more robust performance over longer distances, for example, by boosting the power and repeating the information carried in the communication frames. However, this feature also may reduce the rate at which data can be transmitted, thus making the ER frame format less desirable (compared to non-ER frame formats) for close-range communications. Thus, STAs that are closer in proximity to the AP may prefer to communicate using the ER frame format, whereas STAs that are further from the AP may prefer to communicate using a non-ER frame format.

In some implementations, an HE STA may selectively acquire communication frames transmitted by an AP based at least in part on a preferred frame format for the STA. In some aspects, the preferred frame format may be based, at least in part, on a proximity of the STA to the AP 110. In some other aspects, the preferred frame format based, at least in part, on one or more channel conditions of a wireless channel between the STA and the AP 110. Thus, when associating with a particular AP, an HE STA may first determine whether the AP is capable of formatting communication frames in accordance with multiple PHY formats. In some implementations, the HE STA may determine whether an AP supports multiple PHY formats by examining the HE Operation element of one or more communication frames received from the AP. For example, the HE Operation element may be included in beacon frames, probe response frames, and various other management or control frames.

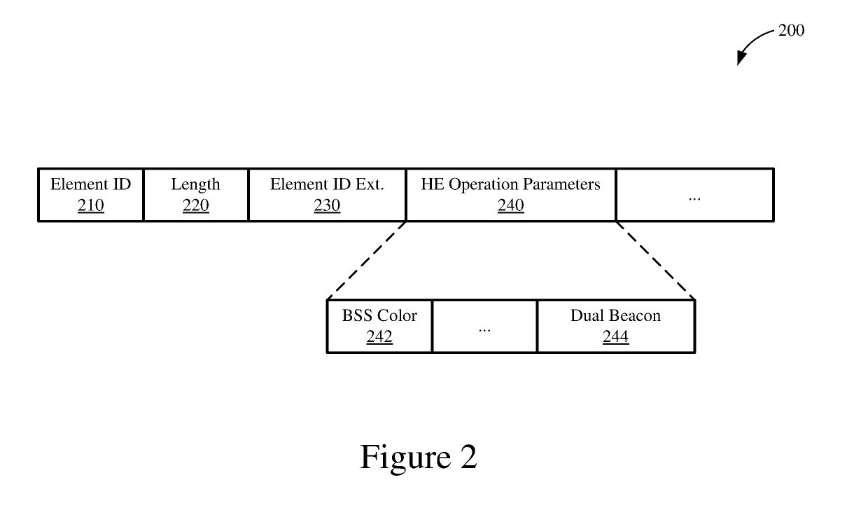

With reference for example to FIG. 2, an HE Operation element 200 may include an “Element ID” field 210, a “Length” field 220, an “Element ID Extension” field 230, an “HE Operation Parameters” field 240, and one or more additional fields for optional sub-elements (not shown for simplicity). For example, the HE Operation element 200 may be provided in beacon and probe response frames transmitted by the AP 110. The Element ID field 210 may store 1 byte of information identifying the element 200 as an HE Operation element. The Length field 220 may store 1 byte of information indicating the length of the HE Operation element 200. The Element ID Extension field 230 may store an additional byte of information as an extension to the Element ID field 210.

The HE Operation Parameters field 240 may store up to 4 bytes of information indicating one or more HE operations or parameters supported by the AP or BSS associated with the HE Operation element 200. More specifically, the HE Operation Parameters field 240 may include a “BSS color” subfield 242 and a “Dual Beacon” subfield 244. The BSS color subfield 242 may store up to 6 bits of information indicating a BSS color associated with the AP or BSS. For example, the BSS color may be used to differentiate communications intended for a particular BSS from communications intended for an overlapping BSS or any other BSSs in the vicinity. The Dual Beacon subfield 244 may store at least 1 bit of data indicating whether the originating AP transmits beacon frames in multiple PHY formats. For example, a value of 0 in the Dual Beacon subfield 244 may indicate that the AP transmits beacons in only the non-ER format. A value of 1 in the Dual Beacon subfield 244 may indicate that the AP transmits beacons in ER and non-ER formats. Thus, upon receiving a beacon frame from an HE AP, the HE STA may quickly identify whether the AP supports multiple PHY formats based on the value stored in the Dual Beacon subfield 244.

When an associated AP supports multiple PHY formats (such as dual beaconing), the HE STA may filter or discard duplicate communication frames received from the AP. In some implementations, the HE STA may discard any duplicate communication frames that are formatted in accordance with any PHY format other than its preferred frame format. For example, if STA1 prefers the primary frame format, STA1 may discard or reject any duplicate communication frames transmitted by the AP 110 in the secondary frame format. Because the various frame formats may be identifiable at the PHY, an HE STA may quickly discard duplicate communications frames (that are not formatted in accordance with the preferred frame format) without passing the communication frames to the MAC for further processing. Still further, in some implementations, an HE STA may signal its preferred frame format to the AP 110. This may allow the AP 110 to selectively transmit communication frames to the HE STA in the preferred frame format only (such as the primary frame format or the secondary frame format), thus avoiding duplicate transmissions altogether.

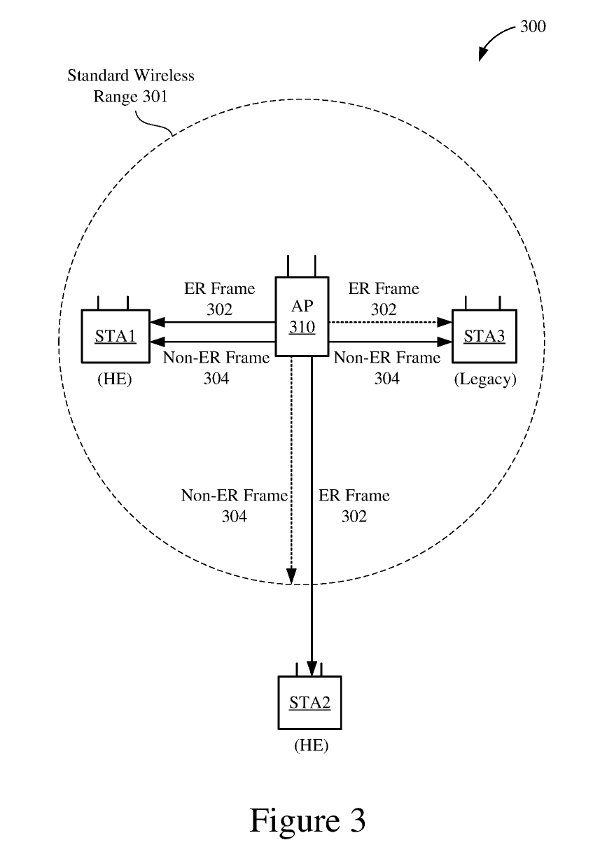

FIG. 3 shows an example wireless system 300 capable of supporting multiple PHY formats. The wireless system 300 is shown to include an access point AP 310 and a number of wireless stations STA1-STA3. With reference, for example, to the wireless system 100 of FIG. 1, the AP 310 may be an implementation of the AP 110. Thus, in the example of FIG. 3, the AP 310 is an HE AP, wireless stations STA1 and STA2 are HE STAs, and STA3 is a legacy STA. Although only three wireless stations STA1-STA3 are shown in the example of FIG. 3 for simplicity, it is to be understood that the wireless system 300 may include any number of STAs.

As shown in FIG. 3, wireless stations STA1 and STA3 are within a standard wireless range 301 of the AP 310. The second wireless station STA2 is beyond the standard wireless range 301. The standard wireless range 301 corresponds to a maximum communication range of the AP 310 using conventional wireless signaling techniques (such as provided under legacy IEEE 802.11 protocols). For example, any legacy communication frames (transmitted by the AP 310) that propagate beyond the standard wireless range 301 may have such a low signal-to-noise ratio (SNR) that they cannot be properly received or decoded by a receiving device. Accordingly, the standard wireless range 301 may represent a threshold distance at which a STA may effectively receive legacy communication frames transmitted or broadcast by the AP 310.

In some implementations, the AP 310 may be configured to transmit communication frames in the ER format to one or more of the wireless stations STA1-STA3. In the example of FIG. 3, stations STA1 and STA2 are HE STAs (capable of implementing ER protocols such as described, for example, by the IEEE 802.11ax specification), and STA3 is a legacy STA (not capable of implementing ER protocols). Since stations STA1 and STA3 are within the standard wireless range 301, the AP 310 may communicate with the stations STA1 and STA3 using legacy or non-ER communication protocols. However, because STA2 is beyond the standard wireless range 301, any non-ER frames transmitted or broadcast by the AP 310 may not be able to reach STA2. Thus, the AP 310 may be able to communicate with STA2 using ER communication protocols only.

To provide support for both legacy and HE STAs, the AP 310 may transmit the same information (intended for one or more of the stations STA1-STA3) in the ER frame format and in a non-ER frame format. For example, in accordance with the IEEE 802.11ax specification, the AP 310 may periodically broadcast beacon frames in the legacy format (such as to maintain connectivity with any legacy or HE STAs within a standard wireless range) and the ER format (such as to maintain connectivity with any HE STAs beyond the standard wireless range). Since the information provided in the beacon frames is typically the same, regardless of whether it is transmitted in the ER frame format or a non-ER frame format, HE STAs that are in relatively close proximity to the HE AP may receive duplicate copies of the beacon information.

In some implementations, the AP 310 may transmit duplicate information to each of the stations STA1-STA3 via broadcast or multicast communication frames formatted in accordance with the ER format (ER frames 302) and a non-ER format (non-ER frames 304). For example, the communication frames 302 and 304 may correspond to beacon frames broadcast by the AP 310 to maintain connectivity with any associated STAs in the vicinity. As another example, each of the communication frames 302 and 304 may be addressed to a multicast group that includes each of the stations STA1-STA3. Because some of the STAs (such as STA2) may be beyond the standard wireless range 301 of the AP 310, and some of the STAs (such as STA3) may be capable of legacy communications only, the AP 310 may transmit the same broadcast or multicast information to the group of stations STA1-STA3 in the non-ER format as well as the ER format.

Since STA3 is a legacy STA, STA3 may not be able to receive or process the ER frames 302. Thus, STA3 may receive the broadcast or multicast information via the non-ER frames 304 only. Since STA2 is beyond the standard wireless range 301 of the AP 310, the non-ER frames 304 may not reach STA2. Thus, STA2 may receive the broadcast or multicast information via the ER frames 302 only. However, because STA1 is an HE STA and is within the standard wireless range 301 of the AP 310, STA1 may receive both the ER frames 302 and the non-ER frames 304 transmitted by the AP 310. As a result, STA1 may receive multiple copies of the same broadcast or multicast information. Processing duplicate communication frames may cause STA1 to consume unnecessary amounts of power and time.

In some implementations, an HE STA may selectively filter or discard duplicate frames received from an HE AP. For example, STA1 may filter communication frames of a particular format (such as the ER format or a non-ER format) based on a proximity of STA1 to the AP 310 or one or more channel conditions that may affect communications between STA1 and the AP 310. As noted above, ER frames are typically transmitted at lower signaling rates than non-ER frames. Thus, in some aspects, an HE STA may filter or discard ER frames (in favor of non-ER frames) if the STA is within a threshold proximity (corresponding to a standard wireless range) of an HE AP. However, it is also noted that interference in the wireless channel may have a greater effect on non-ER frames (than ER frames), thus causing non-ER frames to be retransmitted more frequently. Thus, in some other aspects, an HE STA may filter or discard non-ER frames (in favor of ER frames) if one or more channel conditions is below a threshold level. In the example of FIG. 3, it may be assumed that the channel conditions (within the standard wireless range 301) are ideal for non-ER transmissions. Thus, STA1 may discard or reject the ER frames 302 transmitted by the AP 310, and receive or process only the non-ER frames 304.

In some implementations, an HE STA may determine that it is within a threshold proximity of an HE AP if it is able to receive non-ER frames from the HE AP. For example, STA1 may determine that it is within the standard wireless range 301 of the AP 310 by virtue of the fact that it is able to receive the non-ER frames 304 transmitted by the AP 310. Similarly, STA2 may determine that it is beyond the standard wireless range 301 of the AP 310 if it does not receive any non-ER frames from the AP 310 after a period of time has elapsed (such as a beacon interval). In some other implementations, an HE STA may determine its relative proximity to an HE AP based on well-known ranging or positioning techniques. In some aspects, STA1 may stop filtering the ER frames 302 if it subsequently moves beyond the standard wireless range 301 of the AP 310. Similarly, STA2 may begin filtering the ER frames 302 if it subsequently moves within the standard wireless range 301 of the AP 310.

In some implementations, an HE AP may not transmit duplicate unicast frames to a particular STA. Thus, it may be desirable to distinguish broadcast or multicast frames from unicast frames for purposes of determining which communication frames to filter. The ER frames 302 may be differentiated from the non-ER frames 304 based on the format of their respective PHY headers. For example, the PHY header of a non-ER frame may include an HE SIG-A field of a given length. On the other hand, the HE SIG-A field of an ER frame may be repeated one or more times (resulting in multiple copies of the information provided in the HE SIG-A field). However, the PHY header information may not indicate whether the ER frames 302 or non-ER frames 304 are addressed to a single recipient (unicast frame) or multiple recipients (broadcast or multicast frame). Whether a communication frame is a unicast frame or a broadcast or multicast frame is typically determined at the media access control layer (MAC). However, passing a received communication frame from the PHY to the MAC may consume additional processing overhead and may require an HE STA to remain awake for longer durations. Thus, in some implementations, an HE AP may modify the PHY header of outgoing communication frames to indicate whether they are broadcast or multicast frames.

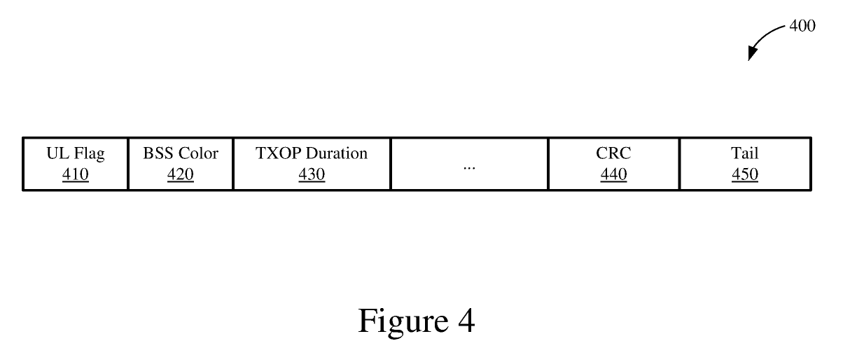

With reference for example to FIG. 4, an HE SIG-A field 400 may include a “UL Flag” subfield 410, a “BSS Color” subfield 420, a “TXOP Duration” subfield 430, a “CRC” subfield 440, a “Tail” subfield 450, and one or more additional subfields (not shown for simplicity). For example, the HE SIG-A field 400 may be included in the PHY header of any HE communication frames transmitted by the AP 310. The UL Flag subfield 410 may store 1 bit of information indicating whether the communication frame is an uplink (UL) transmission or a downlink (DL) transmission. The BSS Color subfield 420 may store up to 6 bits of information indicating the BSS color of the AP 310. The TXOP Duration subfield 420 may store up to 7 bits of information allocating a transmit opportunity (TXOP) to the receiving device (for the duration specified in the subfield 420). The CRC subfield 440 may store up to 4 bits of information that may be used to perform a cyclic redundancy check (CRC) on one or more bits of the HE SIG-A field 400. The Tail subfield 450 may store up to 6 bits of information signaling the termination of the HE SIG-A field 400.

In some implementations, the AP 310 may indicate a broadcast or multicast frame by storing a value of 0 in the TXOP Duration subfield 430 of the HE SIG-A field 400. For example, unicast frames typically provide a transmit opportunity to a recipient STA (TXOP duration>0) to allow the recipient STA to transmit at least an acknowledgement (ACK) frame to the AP in response to the unicast frame. In contrast, broadcast or multicast frames (such as beacon frames) typically do not require acknowledgements from recipient STAs. Thus, a TXOP duration of zero may indicate a broadcast or multicast frame, whereas a non-zero TXOP duration may suggest a unicast frame. In some other aspects, the AP 310 may define or reserve a unique value to be stored in the TXOP Duration subfield 430 that may be used to specifically identify broadcast or multicast ER frames.

In some other implementations, the AP 310 may indicate a broadcast or multicast frame by storing a value of 0 in the UL Flag subfield 410, and storing a value of 0 in the BSS Color subfield 420, of the HE SIG-A field 400. For example, the UL flag is typically used to indicate whether a corresponding communication frame is being transmitted from a STA to an AP (UL flag=1), or from an AP to a STA (UL flag=0). As described above, the BSS color may be used to differentiate multiple BSSs in dense deployment scenarios. Each HE AP in a multi-BSS environment may typically select a 6-bit nonzero BSS color value. For UL transmissions (UL flag=1), a BSS color value of zero may indicate that the communication frame is intend for a recipient STA outside the transmitting STA's BSS. Thus, a BSS color value of zero in a DL transmission (UL flag=0) may be used to indicate a multicast or broadcast frame.

Still further, in some other aspects, the AP 310 may indicate a broadcast or multicast frame by implementing a unique address (such as a group address) for ER-formatted communication frames addressed to multiple HE STAs. The unique address may be provided, for example, in the PHY header of an ER-formatted communication frame. Accordingly, an HE STA may selectively filter broadcast or multicast ER frames (at the PHY) based, at least in part, on the unique address. For example, an HE STA that wishes to filter or discard broadcast or multicast ER frames may do so based on the presence of the unique address (or lack of a well-known legacy address) in the PHY header of received communication frames.

By modifying the PHY header to indicate whether a communication frame is a broadcast or multicast frame, a recipient HE STA may quickly identify and discard duplicate communication frames that are received in the ER (or non-ER) format. More specifically, the HE STA may discard any duplicate frames at the PHY, without having to forward the duplicate frames to the MAC for further processing. In some aspects, a STA may enter a power save mode when it detects unicast frames in a frame format other than its preferred frame format. For example, an HE STA with a preference for the non-ER frame format may enter a power save mode when it detects ER frames being transmitted over the wireless medium. More specifically, the HE STA may remain in the power save mode for at least the duration of the unicast frame or transmission.

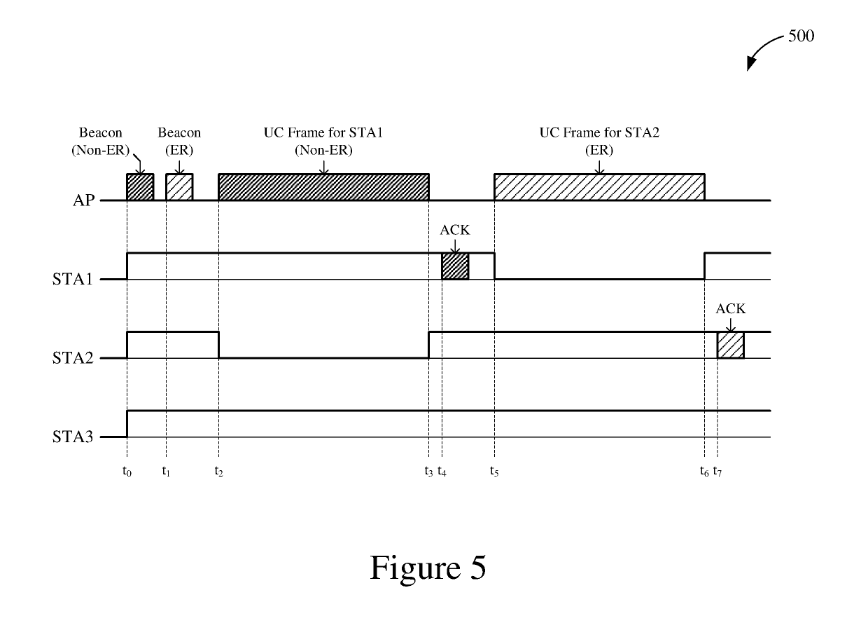

FIG. 5 shows a timing diagram 500 depicting an example operation for filtering communication frames based on a preferred frame format. The AP and wireless stations STA1-STA3 may be implementations of the AP 310 and wireless stations STA1-STA3, respectively, of FIG. 3. For example, the AP may be an HE AP capable of formatting communication frames in accordance with multiple PHY formats, STA1 may be an HE STA having a preference for the non-ER format, STA2 may be an HE STA having a preference for the ER format, and STA3 may be a legacy STA.

At time t₀, the AP 310 broadcasts a beacon frame formatted in accordance with a non-ER format. The first wireless station STA1 initially receives the non-ER beacon frame at its PHY and may determine, based on the PHY header of the received beacon frame, that the non-ER beacon frame is formatted in accordance with the STA's preferred frame format. Upon determining that the received beacon frame is formatted in accordance with its preferred frame format, STA1 may forward the non-ER beacon frame from its PHY to its MAC for further processing. The third wireless station STA3 also receives the non-ER beacon frame at its PHY, and may forward the received beacon frame from its PHY to its MAC for further processing. More specifically, because STA3 is a legacy STA, it may be unable to distinguish the PHY format of the non-ER beacon frame from other available PHY formats.

In some aspects, the second wireless station STA2 may be beyond the standard wireless range of the AP (such as shown in the example of FIG. 3), and may thus be unable to receive the non-ER beacon frame broadcast at time t₀. In some other aspects, STA2 may initially receive the non-ER beacon frame at its PHY and may determine, based on the PHY header of the received beacon frame, that the non-ER beacon frame is not formatted in accordance with the STA's preferred frame format. In some implementations, STA2 also may determine, based on the PHY header, that the received beacon frame is a broadcast communication frame. Because the non-ER beacon frame is a broadcast (or multicast) communication frame that is not formatted in accordance with the STA's preferred frame format, STA2 may determine that the non-ER beacon frame is a duplicate frame (or carries duplicate beacon information). Thus, STA2 may filter or discard the non-ER beacon frame at its PHY (and thus does not forward the non-ER beacon frame to its MAC for further processing).

At time t₁, the AP 310 broadcasts a beacon frame formatted in accordance with the ER format. The first wireless station STA1 may initially receive the ER beacon frame at its PHY and may determine, based on the PHY header of the receive beacon frame, that the ER beacon frame is not formatted in accordance with the STA's preferred frame format. In some implementations, STA1 also may determine, based on the PHY header, that the received beacon frame is a broadcast communication frame. Because the ER beacon frame is a broadcast (or multicast) communication frame that is not formatted in accordance with the STA's preferred frame format, STA1 may determine that the ER beacon frame is a duplicate frame (or carries duplicate beacon information). Thus, STA1 may filter or discard the ER beacon frame at its PHY (and thus does not forward the ER beacon frame to its MAC for further processing).

The second wireless station STA2 initially receives the ER beacon frame at its PHY and may determine, based on the PHY header of the received beacon frame, that the ER beacon frame is formatted in accordance with the STA's preferred frame format. Upon determining that the received beacon frame is formatted in accordance with its preferred frame format, STA2 may forward the ER beacon frame from its PHY to its MAC for further processing. As described above, the third wireless station STA3 may be a legacy STA, and may thus be unable to recognize communication frames formatted in accordance with the ER format. Thus, STA3 may not receive the ER beacon frame broadcast by the AP.

At time t₂, the AP begins transmitting a unicast (UC) frame (such as a data frame) intended only for STA1. Thus, the unicast frame may be formatted in accordance with the preferred frame format for STA1 (such as a non-ER format). The first wireless station STA1 receives the non-ER unicast frame and may determine, based on the PHY header, that the non-ER unicast frame is formatted in accordance with the STA's preferred frame format. Upon determining that the received unicast frame is formatted in accordance with its preferred frame format, STA1 may forward the non-ER unicast frame from its PHY to its MAC for further processing. The third wireless station STA3 also may receive the unicast frame at its PHY, but may discard the received unicast frame upon determining that it is not the intended recipient of the non-ER unicast frame.

In some aspects, the second wireless station STA2 may initially receive the non-ER unicast frame at its PHY and may determine, based on the PHY header of the received unicast frame, that the non-ER unicast frame is not formatted in accordance with the STA's preferred format. In some implementations, STA2 also may determine, based on the PHY header, that the received unicast frame is not a broadcast (or multicast) communication frame. Because the non-ER unicast frame is not a broadcast (or multicast) frame, nor formatted in accordance with the STA's preferred frame format, STA2 may determine that the non-ER unicast frame is intended for a particular wireless station other than STA2. Thus, STA2 may filter or discard the non-ER unicast frame at its PHY. In some implementations, STA2 may enter a power save mode, for the length or duration of the unicast frame (such as from times t₂ to t₃), upon detecting the non-ER unicast frame.

The AP terminates (or completes) the transmission of the non-ER unicast frame at time t₃. In some implementations, STA2 may return from the power save mode at this time to resume listening for incoming communications from the AP (or other devices in the wireless network). The first wireless station STA1 may transmit an acknowledgement message (ACK), at time t₄, acknowledging receipt of the non-ER unicast frame.

At time t₅, the AP begins transmitting a unicast frame (such as a data frame) intended only for STA2. Thus, the unicast frame may be formatted in accordance with the preferred frame format for STA2 (such as the ER format). The first wireless station STA1 may initially receive the ER unicast frame at its PHY and may determine, based on the PHY header of the received unicast frame, that the ER unicast frame is not formatted in accordance with the STA's preferred format. In some implementations, STA1 also may determine, based on the PHY header, that the received unicast frame is not a broadcast (or multicast) communication frame. Because the ER unicast frame is not a broadcast (or multicast) frame, nor formatted in accordance with the STA's preferred frame format, STA1 may determine that the ER unicast frame is intended for a particular wireless station other than STA1. Thus, STA1 may filter or discard the ER unicast frame at its PHY. In some implementations, STA1 may enter a power save mode, for the length or duration of the unicast frame (such as from times t₅ to t₆), upon detecting the ER unicast frame.

The second wireless station STA2 receives the ER unicast frame and may determine, based on the PHY header, that the ER unicast frame is formatted in accordance with the STA's preferred frame format. Upon determining that the received unicast frame is formatted in accordance with its preferred frame format, STA2 may forward the ER unicast frame from its PHY to its MAC for further processing. As described above, the third wireless station STA3 may be a legacy STA, and may thus be unable to recognize communication frame formatted in accordance with the ER format. Thus, STA3 may be unable to detect the ER unicast frame transmitted by the AP.

The AP terminates (or completes) the transmission of the ER unicast frame at time t₆. In some implementations, STA1 may return from the power save mode at this time to resume listening for incoming communications from the AP (or other devices in the wireless network). The second wireless station STA2 may transmit an acknowledgment message, at time t₇, acknowledging receipt of the ER unicast frame.

As described above, the AP may transmit duplicate broadcast or multicast information, via ER frames and non-ER frames, to provide support for a wide range of STAs such as, for example, legacy STAs (such as STA3) and STAs that may be located beyond the standard wireless range of the AP 310 (such as STA2). However, it may be inefficient and redundant to transmit duplicate unicast information that is addressed to a single recipient STA. Thus, in some implementations, an HE AP may selectively transmit unicast frames to HE STAs using the preferred frame format (such as the ER format or a non-ER format) for each recipient STA. Since the preferred frame format for a particular STA may change over time (due to movements of the STA or changes in channel conditions), it may be desirable to dynamically adjust the preferred frame format for a particular STA at any given time.

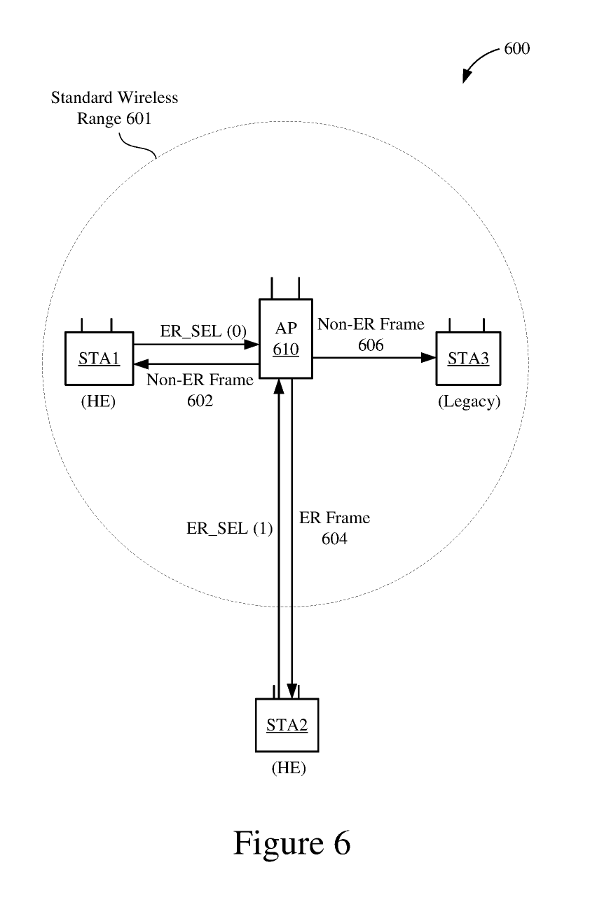

FIG. 6 shows an example wireless system 600 in which an HE AP may configure outgoing communication frames for a particular format based on a proximity of a recipient STA. The wireless system 600 is shown to include an access point AP 610 and a number of wireless stations STA1-STA3. With reference, for example, to the wireless system 100 of FIG. 1, the AP 610 may be an implementation of the AP 110. Thus, in the example of FIG. 6, the AP 610 is an HE AP, wireless stations STA1 and STA2 are HE STAs, and STA3 is a legacy STA. Although only three wireless stations STA1-STA3 are shown in the example of FIG. 6 for simplicity, it is to be understood that the wireless system 600 may include any number of STAs.

As shown in FIG. 6, wireless stations STA1 and STA3 are within a standard wireless range 601 of the AP 610. The second wireless station STA2 is beyond the standard wireless range 601. Furthermore, wireless stations STA1 and STA2 are HE STAs, whereas STA3 is a legacy STA. Since wireless stations STA1 and STA3 are within the standard wireless range 601, the AP 610 may communicate with the wireless stations STA1 and STA3 using legacy or non-ER communication protocols. However, because STA2 is beyond the standard wireless range 601, the AP 610 may be able to communicate with STA2 using ER communication protocols only.

In some implementations, the HE wireless stations STA1 and STA2 may indicate a preference for a particular frame format (such as the ER format or a non-ER format) to the AP 610. For example, the stations STA1 and STA2 may provide an extended range selection (ER_SEL) indicator to the AP 610 indicating their respective preferences for ER frames or non-ER frames. As described above, the preferred frame format for a particular STA may depend on a number of factors such as, for example, a proximity of the STA to an associated AP or one or more channel conditions. In the example of FIG. 6, it may be assumed that the channel conditions (within the standard wireless range 601) are ideal for non-ER transmissions. Thus, HE STAs that are within a standard wireless range 601 of the AP 610 (such as STA1) may prefer to receive communication frames in a non-ER format, whereas HE STAs that are beyond the standard wireless range 601 (such as STA2) may prefer to receive communication frames in the ER format. Accordingly, STA1 may indicate to the AP 610 that it does not wish to receive ER frames, for example, by signaling an ER_SEL value of zero. Similarly, STA2 may indicate to the AP 610 that it wishes to receive ER frames, for example, by signaling an ER_SEL value of one.

Upon receiving an ER_SEL value from an HE STA, the AP 610 may be configured to transmit unicast communication frames to the HE STA in the preferred format of the recipient STA. For example, upon receiving the ER_SEL value from STA1, the AP 610 may subsequently transmit unicast frames 602 in a non-ER format to STA1. Similarly, upon receiving the ER_SEL value from STA2, the AP 610 may subsequently transmit unicast frames 604 in the ER format to STA2. In some implementations, an HE AP may transmit ER-formatted unicast frames to an associated STA only if the STA indicates a preference for unicast frames in the ER format. Thus, since the legacy station STA3 does not support HE protocols (and therefore cannot indicate a preferred frame format), the AP 610 may transmit unicast frames 606 in a non-ER format to STA3.

In some implementations, the ER_SEL indicator may be provided as a field in the HE Capabilities element or HE Operation element (such as the HE Operation element 200 of FIG. 2) of one or more frames exchanged between the HE STA and the HE AP during an association procedure. However, this may cause the HE AP to implement the same PHY format for a particular HE STA for the duration in which the STA remains associated with the AP. For example, if STA2 indicates to the AP 610, during association, that it prefers to receive communication frames in the ER format, the AP 610 may then transmit only ER-formatted unicast frames 604 to STA2 (as long as STA2 remains associated with the AP 610). However, if STA2 eventually moves within the standard wireless range 601 of the AP 610, the AP 610 may continue transmitting only ER-formatted unicast frame 604 to STA2 (even though STA2 may prefer the non-ER format once it is within the standard wireless range 601).

In some other implementations, the ER_SEL indicator may be provided in a dynamic manner to enable the HE STA to adjust or update its preferred frame format (such as from the ER format to a non-ER format, and vice-versa), for example, based on a relative proximity of the HE STA to the HE AP at any given time. The IEEE 802.11ax specification describes an operating mode indication (OMI) procedure that enables an HE STA to dynamically change one or more operating mode settings while remaining associated with an HE AP. In some implementations, an HE STA may leverage the OMI procedure to dynamically indicate or update its preferred frame format to an associated AP. For example, an HE STA may initiate a receive operating mode indicator (ROMI) procedure by transmitting, to the associated AP, a communication frame (such as a QoS Data frame or a QoS Null frame) with an OMI A-Control field indicating a change to its preferred frame format or any other receive operating parameters (such as supported bandwidth or number of spatial streams). The HE AP may respond to the information indicated in the OMI A-Control field by transmitting an ACK frame back to the HE STA. Upon transmitting the ACK frame to the HE STA, the HE AP may immediately begin implementing the preferred frame format (and any other changes in operating parameters) for downlink communication frames transmitted to the HE STA.

For example, when STA1 is within the standard wireless range 601 of the AP 610, STA1 may transmit a communication frame to the AP 610 with an OMI A-Control field indicating a preference for non-ER frames. The AP 610 may respond to the OMI A-Control field by transmitting an ACK frame back to STA1 and subsequently transmitting unicast non-ER frames 602 to STA1. If STA1 moves beyond the wireless range 601 of the AP 610, STA1 may transmit another communication frame to the AP 610 with an OMI A-Control field indicating a preference for ER frames. The AP 610 may respond to the OMI A-Control field by transmitting an ACK frame back to STA1 and formatting subsequent unicast frames addressed to STA1 in the ER format.

Similarly, when STA2 is beyond the standard wireless range 601 of the AP 610, STA2 may transmit a communication frame to the AP 610 with an OMI A-Control field indicating a preference for ER frames. The AP 610 may respond to the OMI A-Control field by transmitting an ACK frame back to STA2 and subsequently transmitting unicast ER frames 604 to STA2. If STA2 moves within the wireless range 601 of the AP 610, STA2 may transmit another communication frame to the AP 610 with an OMI A-Control field indicating a preference for non-ER frames. The AP 610 may respond to the OMI A-Control field by transmitting an ACK frame back to STA2 and formatting subsequent unicast frames addressed to STA2 in a non-ER format.

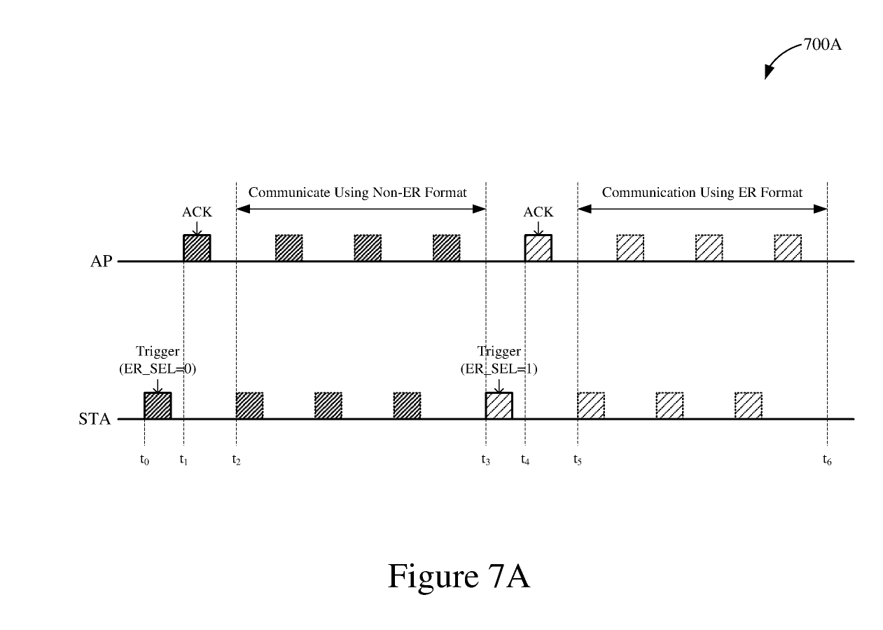

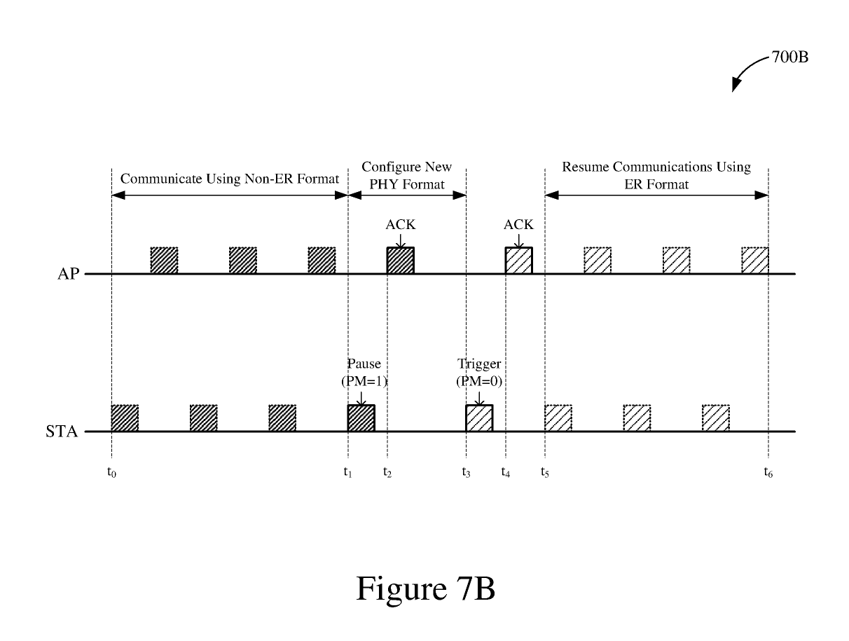

FIG. 7A shows a timing diagram 700A depicting an example operation for dynamically changing the preferred frame format for an HE STA. The AP may be an example implementation of the AP 610, and the STA may be an example implementation of one of the wireless stations STA1 or STA2, of FIG. 6. For example, the AP may be an HE AP capable of formatting communication frames in accordance with multiple PHY formats, and the STA may be an HE STA having a preference for one of the multiple PHY formats.

At time t₀, the STA transmits a trigger frame to the AP to signal a change in its preferred frame format. More specifically, the STA may indicate a preference for a non-ER format (ER_SEL=0). With reference for example to FIG. 6, the STA may be within the standard wireless range 601 of the AP 610, at time t₀, and may thus benefit from the higher signaling rates afforded by the non-ER format. In some implementations, the trigger frame may be a QoS Null (or Data) frame including an OMI A-Control field indicating a change to the STA's preferred frame format. In some aspects, the QoS Null frame may be formatted in accordance with the non-ER format. The AP may respond to the trigger frame by sending an acknowledgment (ACK) message back to the STA at time t₁. Thereafter, from times t₂ to t₃, the AP and STA may communicate using the preferred frame format of the STA (such as the non-ER format).

At time t₃, the STA transmits another trigger frame to the AP to signal a change in its preferred frame format. More specifically, the STA may indicate a preference for the ER format (ER_SEL=1). With reference for example to FIG. 6, the STA may have moved beyond the standard wireless range 601 of the AP 610, at time t₃, and may thus benefit from the extended communication range afforded by the ER format. In some implementations, the trigger frame may be a QoS Null (or Data) frame including an OMI A-Control field indicating a change to the STA's preferred frame format. In some aspects, the QoS Null frame may be formatted in accordance with the ER format. The AP may respond to the trigger frame by sending an acknowledgement message back to the STA at time t₄. Thereafter, from times t₅ to t₆, the AP and STA may communicate using the new preferred frame format of the STA (such as the ER format).

It is noted that changing the preferred frame format for an HE STA may not occur instantaneously. For example, it may take some time to configure (or reconfigure) the STA to transmit, receive, or filter communication frames based on a new PHY format. Thus, in some aspects, the HE STA may send a communication frame to the associated AP with a power management (PM) bit set to one, for example, to temporarily suspend downlink transmissions from the AP while the STA implements the new frame format configuration. After the new frame format configuration has been successfully implemented, the HE STA may then send a QoS Null frame with a PM bit set to zero, for example, to resume downlink transmission from the AP.

FIG. 7B shows another timing diagram 700B depicting an example operation for dynamically changing the preferred frame format for an HE STA. The AP may be an example implementation of the AP 610, and the STA may be an example implementation of one of the wireless stations STA1 or STA2, of FIG. 6. For example, the AP may be an HE AP capable of formatting communication frames in accordance with multiple PHY formats, and the STA may be an HE STA having a preference for one of the multiple PHY formats.

In the example of FIG. 7B, the STA may initially prefer the non-ER frame format. With reference for example to FIG. 6, the STA may be within the standard wireless range 601 of the AP 610, from times t₀ to t₁, and may thus benefit from the increased signaling rate afforded by the non-ER format. Accordingly, from times t₀ to t₁, the AP and STA may communicate using the non-ER frame format. At time t₁, the STA may no longer prefer the non-ER frame format. For example, the STA may have moved beyond the standard wireless range 601 of the AP 610, at time t₁, and may thus benefit from the extended communication range afforded by the ER format.

The STA may send a pause message to the AP, at time t₁, to temporarily pause communications with the AP. For example, it may be desirable to pause communications with the AP to ensure that the STA does not miss any downlink data while undergoing a change in its preferred frame format. In some implementations, the pause message may be QoS Null (or Data) frame including a power management bit set to one (PM=1). Upon receiving the pause message, the AP may suspend downlink transmissions intended for the STA. In some aspects, the AP may respond to the pause message by sending an acknowledgement message back to the STA at time t₂. While communications between the AP and the STA are temporarily suspended, from times t₁ to t₃, the STA may proceed to implement any configurations necessary to transmit, receive, or filter communication frames based on the preferred ER format.

When the STA is configured for the new PHY format, at time t₃, the STA may transmit a trigger frame to the AP to signal a change in its preferred frame format. More specifically, the STA may indicate a preference for the ER format (ER_SEL=1). In some implementations, the trigger frame may be a QoS Null (or Data) frame including an OMI A-Control field indicating a change to the STA's preferred frame format. In some aspects, the QoS Null frame may be formatted in accordance with the ER format. In some other aspects, the QoS Null frame may include a power management set to zero (PM=0) to resume communications with the AP. The AP may respond to the trigger frame by sending an acknowledgement message back to the STA at time t₄. Thereafter, from times t₅ to t₆, the AP and STA may resume communications using the new preferred frame format of the STA (such as the ER format).

By leveraging ROMI signaling procedures to indicate the preferred frame format of an HE STA, an associated AP may dynamically change the PHY format used for downlink transmissions to the HE STA at any given time (while remaining associated with the AP). For example, the HE STA may receive unicast frames in a non-ER format when the STA is within a standard wireless range of the AP or when channel conditions are relatively good. Similarly, the HE STA may receive unicast frames in the ER format when the STA is beyond the standard wireless range of the AP or when channel conditions are relatively poor. Accordingly, the HE AP may conserve power and time by avoiding transmissions of duplicate unicast frames to the HE STA.

In some implementations, rather than transmit duplicate communication frames (in different PHY formats) on behalf of the same BSS, an HE AP may be configured as a plurality of “virtual” BSSs each configured for a different PHY format. For example, an AP hosting multiple BSSIDs may be configured to provide multiple virtual local area networks (VLANs), where each VLAN corresponds to a respective BSS. Each virtual BSS may be identified by a different BSS identifier (BSSID). Accordingly, different STAs may connect to different VLANs by associating with the corresponding BSS. In some aspects, each virtual BSS may be configured to format communication frames in accordance with a single PHY format (such as the ER format or the non-ER format). However, since different BSSs may be configured for different PHY formats, the same (physical) AP may still be able to support a plurality of different PHY formats.

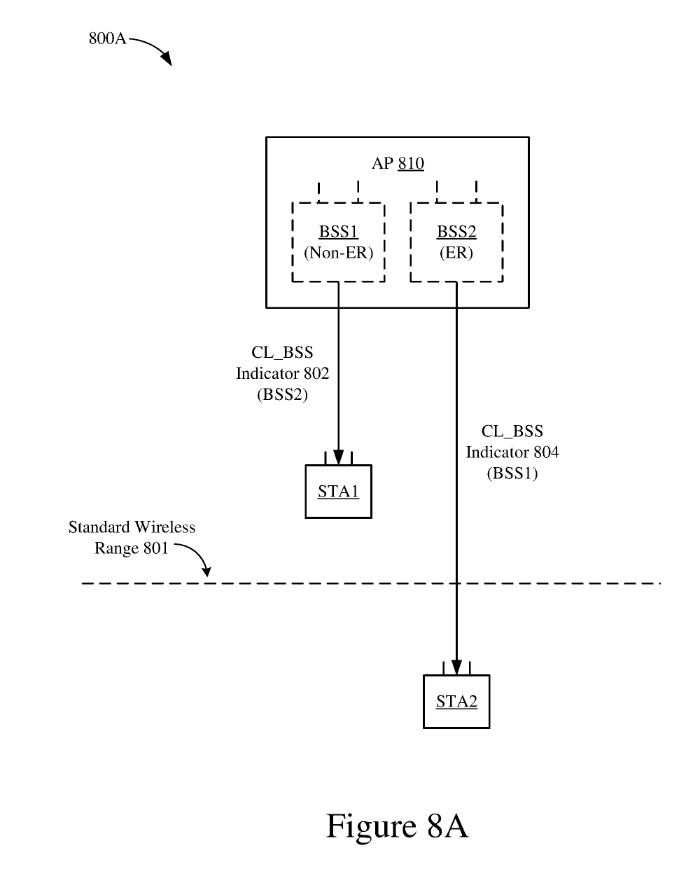

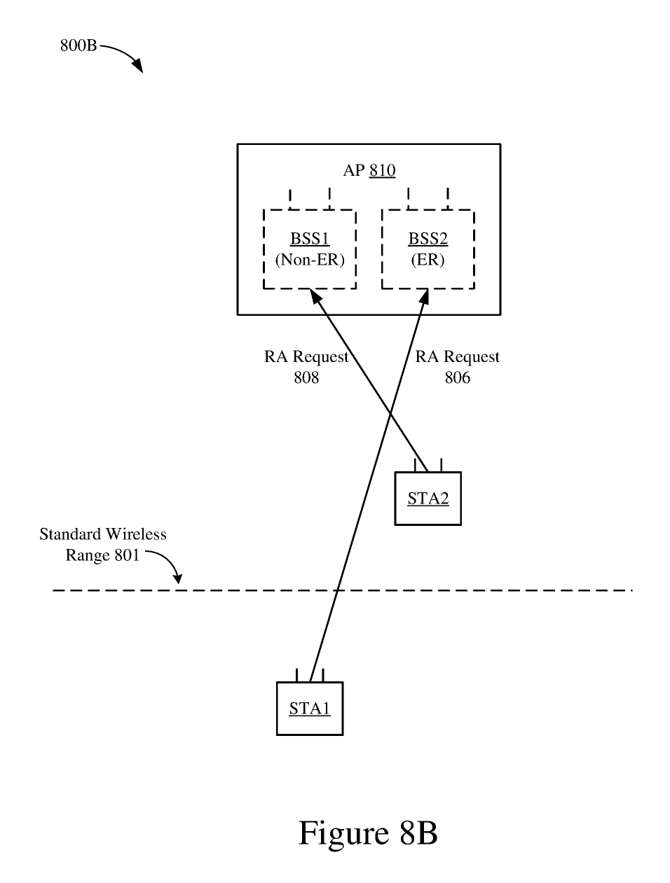

FIG. 8A shows another example wireless system 800A capable of supporting multiple PHY formats. The wireless system 800A is shown to include an access point AP 810 and wireless stations STA1 and STA2. In the example of FIG. 8A, the AP 810 is an HE AP serving as two Basic Service Sets BSS1 and BSS2, and the wireless stations STA1 and STA2 are HE STAs. Although only Basic Service Sets BSS1 and BSS2 are shown in the example of FIG. 8A for simplicity, it is to be understood that the AP 810 may serve as any number of virtual BSSs.

In some implementations, each of the Basic Service Sets BSS1 and BSS2 is configured for a different PHY format. For example, BSS1 may be configured to format communication frames in accordance with the non-ER format, and BSS2 may be configured to format communication frames in accordance with the ER format. Thus, BSS1 may support legacy STAs (not shown for simplicity) and HE STAs that are within a standard wireless range 801 of the AP 810 (or otherwise prefer the non-ER format). On the other hand, BSS2 may support HE STAs that are beyond the standard wireless range 801 (or otherwise prefer the ER format). In some aspects, neither of the Basic Service Sets BSS1 or BSS2 is configured to support multiple PHY formats.

In the example of FIG. 8A, STA1 is within the standard wireless range 801 of the AP 810 and STA2 is beyond the standard wireless range 801. Since STA1 is within the standard wireless range 801, STA1 may prefer the non-ER format as its preferred frame format (such as described with respect to FIGS. 1-7B). Accordingly, STA1 may be initially associated with BSS1. For example, when scanning for a BSS to associate with, STA1 may detect ER beacons (or probe responses) from BSS2 and non-ER beacons (or probe responses) from BSS1. Upon receiving a beacon or probe response frame formatted in accordance with the non-ER format, STA1 may proceed to associate with BSS1. Since STA2 is beyond the standard wireless range 801, STA2 may prefer the ER format as its preferred frame format (such as described with respect to FIGS. 1-7B). Accordingly, STA2 may be initially associated with BSS2. For example, since it is out of range of BSS1, STA2 may detect ER beacons (or probe responses) only from BSS2 when scanning for a BSS to associate with. Upon receiving a beacon or probe response frame formatted in accordance with the ER format, STA2 may proceed to associate with BSS2.

As described with respect to FIGS. 6-7B, the preferred frame format for a particular STA may dynamically change based on movements of the STA or changing channel conditions. Thus, it may be desirable to allow any HE STA associated with the AP 810 to dynamically switch the virtual BSS with which it is associated (such as between BSS1 and BSS2). In some implementations, each of the Basic Service Sets BSS1 and BSS2 may be configured to transmit a respective co-located BSS (CL_BSS) indicator 802 and 804 to any STAs in the vicinity of the AP 810. For example, the CL_BSS indicators 802 and 804 may be included in beacon frames, probe response frames, or other management frames transmitted by a BSS. In some implementations, each of the CL_BSS indicators 802 and 804 may indicate the identity and supported PHY format of a co-located BSS. As used herein, the term “co-located BSS” may refer to any BSSs that occupy substantially the same physical location or share one or more hardware components (such as the antenna connectors of an AP). Thus, virtual BSSs belonging to the same physical AP (such as BSS1 and BSS2) may be referred to as co-located BSSs.

In some implementations, the CL_BSS indicator may be provided in a neighbor report. For example, the neighbor report (as defined by the IEEE 802.11 standards) may indicate the presence, locations, and capabilities of other BSSs in the vicinity of an associated BSS (or the BSS that generated the report). In some aspects, the neighbor report may include one or more bits of information indicating the PHY format supported by each BSS identified in the report (such as whether the BSS is configured for the ER or non-ER format) and a bit of information indicating whether each identified BSS is co-located with the BSS that generated the report. The neighbor report also may include additional information about the capabilities or operating parameters for each BSS identified in the report. In the example of FIG. 8A, the CL_BSS indicator 802 transmitted by BSS1 may identify BSS2 as a co-located BSS that supports the ER format, and the CL_BSS indicator 804 transmitted by BSS2 may identify BSS1 as a co-located BSS that supports the non-ER format.

The wireless stations STA1 and STA2 may use the information provided in the CL_BSS indicators 802 and 804, respectively, to dynamically switch between the Basic Service Sets BSS1 and BSS2. In some implementations, an HE STA may associate with a different virtual BSS depending on its preferred frame format at any given time. With reference for example to the wireless system 800B of FIG. 8B, STA1 may eventually move beyond the standard wireless range 801 of the AP 810 and STA2 may eventually move within the standard wireless range 801. As a result of this movement, STA1 may now prefer the ER format and STA2 may now prefer the non-ER format.

In some implementations, STA1 may have identified BSS2 as a co-located BSS that supports the ER format, for example, based on the CL_BSS indicator 802 and other information included in the neighbor report transmitted by BSS1. Thus, STA1 may immediately send a reassociation (RA) request 806 to BSS2 when its preferred frame format changes (without having to perform a scanning operation). Since STA1 may already have knowledge of most, if not all, of the capabilities, operating parameters, or configurations of BSS2 as well as the AP 810, the reassociation operation (between STA1 and BSS2) may be completed relatively quickly. Thus, any ongoing communications between the AP 810 (via BSS1) and STA1 may be resumed (via BSS2) with minimal delay.

In some implementations, STA2 may have identified BSS1 as a co-located BSS that supports the non-ER format, for example, based on the CL_B SS indicator 804 and other information included in the neighbor report transmitted by BSS2. Thus, STA2 may immediately send a reassociation request 808 to BSS1 when its preferred frame format changes (without having to perform a scanning operation). Since STA2 may already have knowledge of most, if not all, of the capabilities, operating parameters, or configurations of BSS1 as well as the AP 810, the reassociation operation (between STA2 and BSS1) may be completed relatively quickly. Thus, thus any ongoing communications between the AP 810 (via BSS2) and STA2 may be resumed (via BSS1) with minimal delay.

By hosting multiple BSSIDs, an HE AP may provide support for legacy STAs and HE STAs having different preferred frame formats. However, because each virtual BSS may be configured for a single (different) PHY format, none of the HE STAs may be required to perform filtering on any received communication frames. Rather, when the preferred PHY format for an HE STA changes, the STA may select a different BSS to associate with (such as described with respect to FIG. 1). Moreover, because the virtual BSSs (hosted by the same AP) are co-located, the HE STA may quickly transition from one BSS to another when its preferred frame format changes. Among other advantages, aspects of the present disclosure may provide IP continuity, faster discovery, and faster reassociation when transitioning between co-located BSSs (compared to conventional techniques of transitioning between different BSSs).

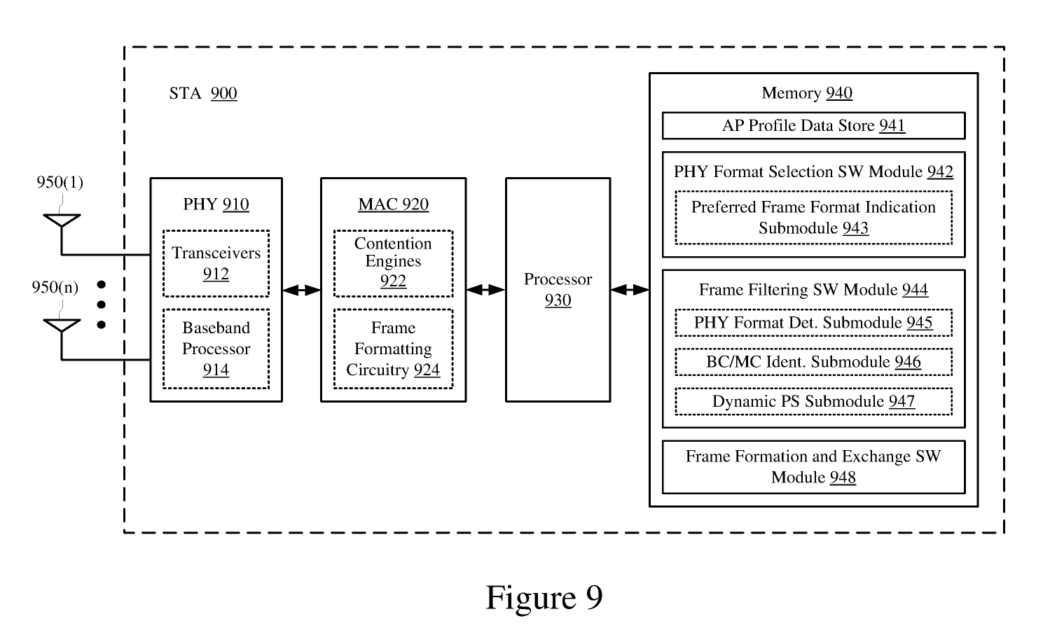

FIG. 9 shows a block diagram of an example wireless station (STA) 900. In some implementations, the STA 900 may be an HE STA that supports multiple PHY formats (such as the ER format and a non-ER format). For example, the STA 900 may be an example implementation of any of the wireless stations STA1 or STA2 of FIG. 1, FIG. 3, or FIG. 6. The STA 900 may include a PHY 910, a MAC 920, a processor 930, a memory 940, and a number of antennas 950(1)-950(n).

The PHY 910 may include a number of transceivers 912 and a baseband processor 914. The transceivers 912 may be coupled to the antennas 950(1)-950(n), either directly or through an antenna selection circuit (not shown for simplicity). The transceivers 912 may be used to communicate wirelessly with one or more APs, with one or more STAs, or with other suitable devices. The baseband processor 914 may be used to process signals received from the processor 930 or the memory 940 and to forward the processed signals to the transceivers 912 for transmission via one or more of the antennas 950(1)-950(n), and may be used to process signals received from one or more of the antennas 950(1)-950(n) via the transceivers 912 and to forward the processed signals to the processor 930 or the memory 940.

Although not shown in FIG. 9, for simplicity, the transceivers 912 may include any number of transmit chains to process and transmit signals to other wireless devices via the antennas 950(1)-950(n), and may include any number of receive chains to process signals received from the antennas 950(1)-950(n). Thus, in some implementations, the STA 900 may be configured for MIMO operations including, for example, single-user MIMO (SU-MIMO) operations and multi-user (MU-MIMO) operations. In addition, the STA 900 may be configured for OFDMA communications or other suitable multiple access mechanisms, for example, as may be specified by any of the IEEE 802.11 standards.

The MAC 920 may include at least a number of contention engines 922 and frame formatting circuitry 924. The contention engines 922 may contend for access to the shared wireless medium, and may store packets for transmission over the shared wireless medium. In some implementations, the contention engines 922 may be separate from the MAC 920. Still further, in some implementations, the contention engines 922 may be implemented as one or more software modules (stored in the memory 940 or in memory provided within the MAC 920). The frame formatting circuitry 924 may be used to create or format frames received from the processor 930 or the memory 940 (such as by adding MAC headers to PDUs provided by the processor 930), and may be used to re-format frames received from the PHY 910 (such as by stripping the MAC headers from frames received from the PHY 910).

The memory 940 may include a AP profile data store 941 that stores profile information for a plurality of BSSs. The profile information for a particular BSS may include, for example, the BSSID, MAC address, channel information, received signal strength indicator (RSSI) values, goodput values, channel state information (CSI), supported data rates, connection history with the BSS, a trustworthiness value of the BSS (indicating a level of confidence about the BSS's location or other properties associated with the BSS), and any other suitable information pertaining to or describing the operation of the BSS.

The memory 940 also may include a non-transitory computer-readable medium (one or more nonvolatile memory elements, such as EPROM, EEPROM, Flash memory, a hard drive, and the like) that may store at least the following software (SW) modules:
a PHY format selection SW module 942 to select one of a plurality of supported PHY formats as a preferred frame format for the STA 900, the PHY format selection SW module 942 including:
   a preferred frame format indication submodule 943 to indicate the preferred frame format to an associated AP;
a frame filtering SW module 944 to determine whether to forward an incoming communication frame from the PHY 910 to the MAC 920 based on the preferred frame format, the frame filtering SW module 944 including:
   a PHY format detection submodule 945 to detect the PHY format of a communication frame received at the PHY 910;
   a broadcast/multicast (BC/MC) identification submodule 946 to determine whether a communication frame received at the PHY 910 is a broadcast or multicast frame; and
   a dynamic power save (PS) submodule 947 to toggle between an active mode and a power save mode based at least in part on the preferred frame format; and
a frame formation and exchange SW module 948 to facilitate the creation and exchange of communication frames in accordance with the various PHY formats supported by the STA 900.
   Each software module includes instructions that, when executed by the processor 930, cause the STA 900 to perform the corresponding functions.

For example, the processor 930 may execute the PHY format selection SW module 942 to select one of a plurality of supported PHY formats as a preferred frame format for the STA 900. In executing the PHY format selection SW module 942, the processor 930 may further execute the preferred frame format indication submodule 943 to indicate the preferred frame format to an associated AP. The processor 930 also may execute the frame filtering SW module 944 to determine whether to forward an incoming communication frame from the PHY 910 to the MAC 920 based on the preferred frame format. In executing the frame filter SW module 944, the processor 930 (in conjunction with the PHY 910) may further execute the PHY format detection submodule 945, the BC/MC identification submodule 946, and the dynamic PS submodule 947.

The processor 930 (or the PHY 910) may execute the PHY format detection submodule 945 to detect the PHY format of a communication frame received at the PHY 910. The processor 930 (or the PHY 910) also may execute the BC/MC identification submodule 946 to determine whether a communication frame received at the PHY 910 is a broadcast or multicast frame. Still further, the processor 930 (or the PHY 910) may execute the dynamic PS submodule 947 to toggle between an active mode and a power save mode based at least in part on the preferred frame format. The processor 930 (or the PHY 910) may execute the frame formation and exchange SW module 948 to facilitate the create and exchange of communication frames in accordance with the various PHY formats.

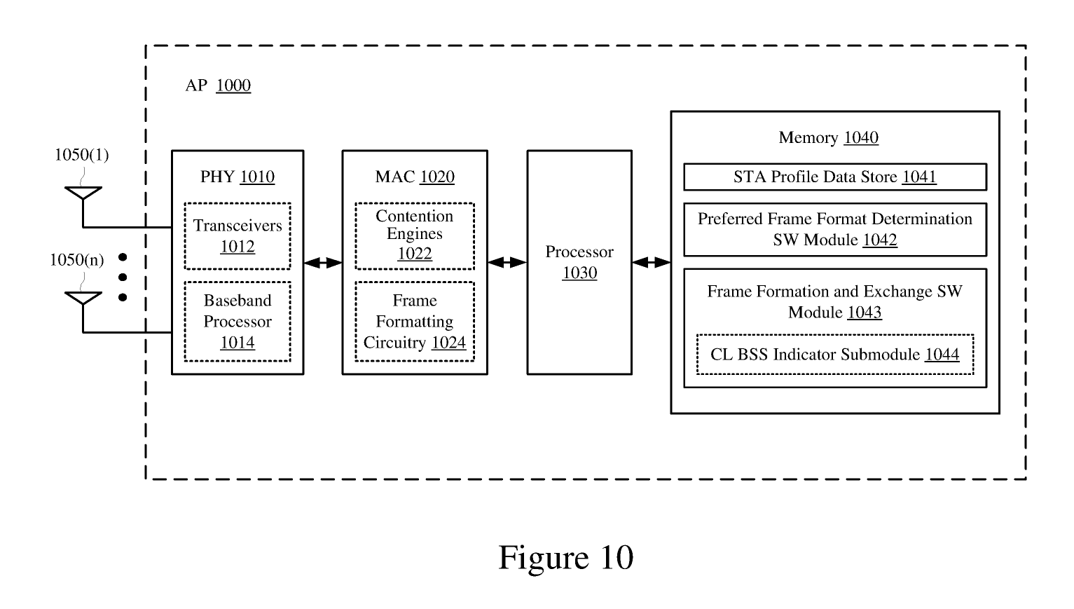

FIG. 10 shows a block diagram of an example access point (AP) 1000. In some implementations, the AP 1000 may be an HE AP that supports multiple PHY formats (such as the ER format and a non-ER format). For example, the AP 1000 may be an example implementation of any of the APs 110, 310, or 610, respectively, of FIG. 1, FIG. 3, or FIG. 6. The AP 1000 may include a PHY 1010, a MAC 1020, a processor 1030, a memory 1040, and a number of antennas 1050(1)-1050(n).

The PHY 1010 may include a number of transceivers 1012 and a baseband processor 1014. The transceivers 1012 may be coupled to the antennas 1050(1)-1050(n), either directly or through an antenna selection circuit (not shown for simplicity). The transceivers 1012 may be used to communicate wirelessly with one or more STAs, with one or more APs, or with other suitable devices. The baseband processor 1014 may be used to process signals received from the processor 1030 or the memory 1040 and to forward the processed signals to the transceivers 1012 for transmission via one or more of the antennas 1050(1)-1050(n), and may be used to process signals received from one or more of the antennas 1050(1)-1050(n) via the transceivers 1012 and to forward the processed signals to the processor 1030 or the memory 1040.

Although not shown in FIG. 10, for simplicity, the transceivers 1012 may include any number of transmit chains to process and transmit signals to other wireless devices via the antennas 1050(1)-1050(n), and may include any number of receive chains to process signals received from the antennas 1050(1)-1050(n). Thus, in some implementations, the AP 1000 may be configured for MIMO operations including, for example, single-user MIMO (SU-MIMO) operations and multi-user (MU-MIMO) operations. In addition, the AP 1000 may be configured for OFDMA communications or other suitable multiple access mechanisms, for example, as may be specified by any of the IEEE 802.11 standards.

The MAC 1020 may include at least a number of contention engines 1022 and frame formatting circuitry 1024. The contention engines 1022 may contend for access to the shared wireless medium, and may store packets for transmission over the shared wireless medium. In some implementations, the contention engines 1022 may be separate from the MAC 1020. Still further, in some implementations, the contention engines 1022 may be implemented as one or more software modules (stored in the memory 1040 or in memory provided within the MAC 1020). The frame formatting circuitry 1024 may be used to create or format frames received from the processor 1030 or the memory 1040 (such as by adding MAC headers to PDUs provided by the processor 1030), and may be used to re-format frames received from the PHY 1010 (such as by stripping the MAC headers from frames received from the PHY 1010).

The memory 1040 may include a STA profile store 1041 that stores profile information for a plurality of STAs. The profile information for a particular STA may include, for example, its MAC address, supported data rates, connection history with the AP 1000, one or more resource units (RUs) allocated to the STA, and any other suitable information pertaining to or describing the operation of the STA.

The memory 1040 also may include a non-transitory computer-readable medium (one or more nonvolatile memory elements, such as EPROM, EEPROM, Flash memory, a hard drive, and the like) that may store at least the following software (SW) modules:
a preferred frame format determination SW module 1042 to determine a preferred frame format for an associated STA; and
a frame formation and exchange SW module 1043 to facilitate the creation and exchange of communication frames in accordance with the various PHY formats supported by the AP 1000, the frame formation and exchange SW module 1043 including:
   Co-located (CL) BSS indicator submodule 1044 to identify one or more a co-located BSSs associated with the AP 1000 and indicate a supported PHY format for each of the co-located BSSs; and
      Each software module includes instructions that, when executed by the processor 1030, cause the AP 1000 to perform the corresponding functions.

For example, the processor 1030 may execute the preferred frame format determination SW module 1042 to determine a preferred frame format for an associated STA. The processor 1030 also may execute the frame formation and exchange SW module 1043 to facilitate the creation and exchange of communication frames in accordance with the various PHY formats supported by the AP 1000. In executing the frame formation and exchange SW module 1043, the processor 1030 may further execute the CL BSS indicator submodule 1044 to identify one or more a co-located BSSs associated with the AP 1000 and indicate a supported PHY format for each of the co-located BSSs.

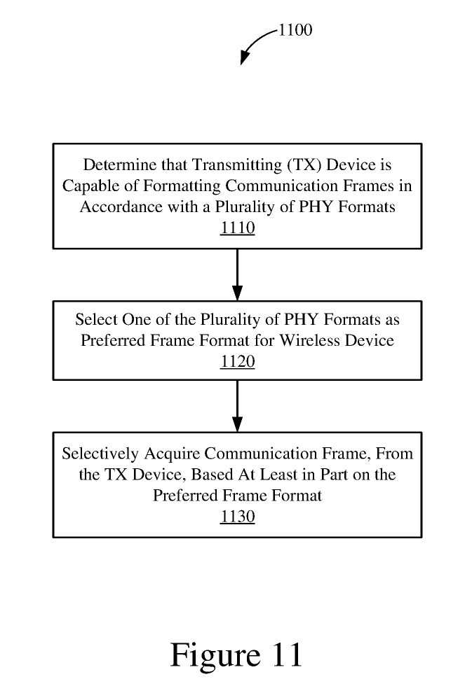

FIG. 11 shows a flowchart depicting an example operation 1100 for selectively acquiring communication frames in a preferred frame format. The operation 1100 may be performed by a wireless device capable of implementing multiple PHY formats such as, for example, stations STA1-STA3 of FIG. 1, FIG. 3, and FIG. 6. With reference for example to FIG. 3, the operation 1100 may be performed by an HE STA (such as STA1 or STA2) to filter duplicate frames received from the AP 310. With reference also to FIG. 6, the operation 1100 may be performed by an HE STA (such as STA1 or STA2) to indicate a preferred frame format to the AP 610. Thus, for purposes of discussion, the operation 1100 may be performed by a receiving (RX) device (such as an HE STA) for purposes of acquiring communication frames from a transmitting (TX) device (such as an HE AP).

The RX device may determine that the TX device is capable of formatting communication frames in accordance with a plurality of PHY formats (1110). In some implementations, the RX device may determine that the TX device supports multiple PHY formats upon receiving two or more communication frames having different PHY formats. For example, the TX device may be an HE AP capable of transmitting communication frames in an ER format and a non-ER format. The RX device may determine that the HE AP is capable formatting communication frames in accordance with the ER format upon detecting ER frames transmitted by the HE AP. In some aspects, the RX device may transmit a request frame (such as a probe request, an association request, or a reassociation request) to the HE AP in the ER format. If the HE AP is capable of supporting the ER format, the HE AP may transmit a response frame (such as a probe response, association response, or reassociation response) back to the RX device also in the ER format.

In some other implementations, the HE AP may indicate its support for the ER format in the PHY header of its communication frames. For example, beacon frames, probe response frames, and other management or control frames transmitted by an HE AP may include an HE Operation element in their respective PHY headers. With reference for example to the HE Operation element 200 of FIG. 2, the HE Operation Parameters field 240 may include a Dual Beacon subfield 244 indicating whether a corresponding HE AP transmits beacons in ER and non-ER formats (or in the non-ER format only). In some aspects, the RX device may determine that the TX device supports multiple PHY formats by examining the Dual Beacon subfield 244 provided in beacon frames, probe response frames, or other management or control frames received from the TX device.

The RX device may select one of the plurality of PHY formats as its preferred frame format (1120). As described above, communication frames transmitted by the TX device to the RX device may perform better when formatted in accordance with a particular PHY format, over other supported PHY formats, under certain conditions (such as proximity of the RX device to the TX device or one or more channel conditions of the wireless channel). For example, an RX device that is within a standard wireless range of the TX device (or under relatively good channel conditions) may prefer to receive communication frames in a non-ER format to take advantage of higher signaling rates. On the other hand, an RX device that is beyond the standard wireless range of the TX device (or under relatively poor channel conditions) may prefer to receive communication frames in the ER format due to the more robust performance at extended ranges. It is noted that the preferred frame format may dynamically change, for example, based on movements of the RX device or changing channel conditions.

The RX device may selectively acquire a communication frame, from the TX device, based at least in part on the preferred frame format (1130). In some aspects, the RX device may receive duplicate frames (in different PHY formats) from the TX device. For example, the duplicate frames may be broadcast or multicast frames addressed to a group of recipient devices that includes the RX device. Accordingly, the RX device may filter or discard any communication frames that are not formatted in accordance with the preferred frame format. More specifically, the RX device may identify and discard the duplicate frames at its PHY (without forwarding the duplicate frames to the MAC for further processing). In some other aspects, the RX device may indicate its preferred frame format to the TX device, for example, to cause the TX device to use only the preferred frame format when transmitting unicast frames to the RX device.

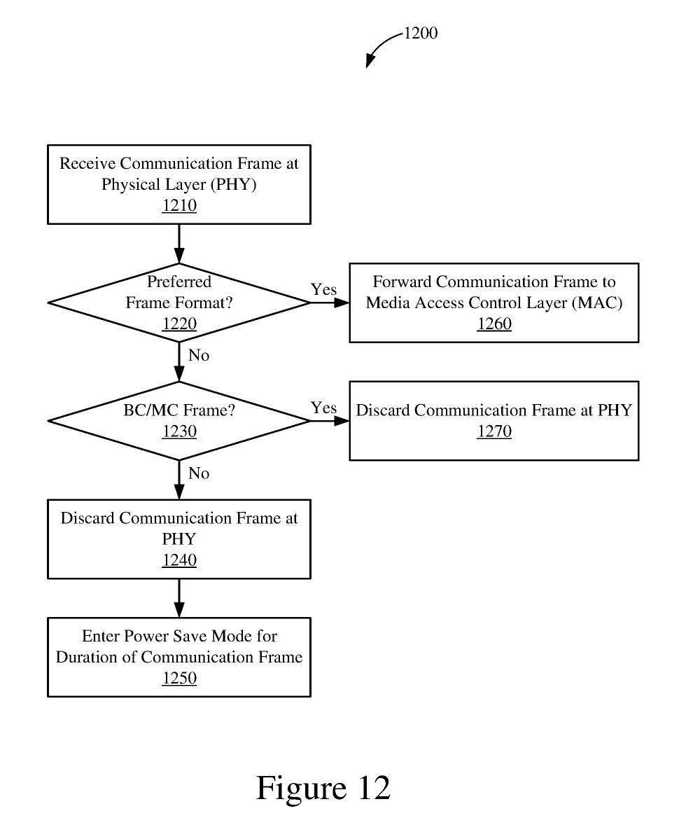

FIG. 12 shows a flowchart depicting an example operation 1200 for filtering incoming communication frames based on a preferred frame format. The operation 1200 may be performed by a STA capable of implementing multiple PHY formats such as, for example, stations STA1-STA3 of FIG. 1, FIG. 3, and FIG. 6. With reference for example to FIG. 3, the operation 1200 may be performed by an HE STA (such as STA1 or STA2) to filter duplicate frames received from the AP 310. More specifically, the filtering of incoming communication frames may be performed at the physical layer (PHY). Thus, in some implementations, the operation 1200 may be performed within the PHY of an HE STA.

The STA may receive a communication frame at its PHY (1210). In some implementations, the STA may analyze the PHY header of the received communication frame to determine whether to discard the communication frame at the PHY, or to forward the communication frame to the media access control layer (MAC) for further processing. For example, the STA may determine whether the received communication frame is formatted in accordance with a preferred frame format (1220), and whether the received communication frame is a broadcast or multicast frame (1230), based on the information included in the PHY header.

If the received communication frame is formatted in accordance with the preferred frame format (as tested at 1220), the STA may forward the communication frame the PHY to the MAC for further processing (1260). The preferred frame format of the STA may correspond to one of a plurality of PHY formats supported by the STA (and the associated AP). For example, the plurality of PHY formats may include an extended range (ER) format and a non-ER format. In some implementations, ER frames may be differentiated from non-ER frames based on the format of their respective PHY headers. For example, the PHY header of a non-ER frame may include an HE SIG-A field of a given length. On the other hand, the HE SIG-A field of an ER frame may be repeated one or more times. If the received communication frame is not formatted in accordance with the preferred frame format (as tested at 1220), the STA may further determine whether the received communication frame is a broadcast or multicast frame (1230).

If the received communication frame is a broadcast or multicast frame (as tested at 1230), the STA may discard the communication frame at the PHY (1270). For example, an AP may transmit broadcast and multicast frames in accordance with multiple PHY formats to ensure that each of the plurality of intended recipients (which may include legacy STAs and HE STAs with different preferred frame formats) is able to receive the broadcast or multicast information. Thus, it may be desirable for the STA to filter duplicate copies of the broadcast or multicast frames at its PHY. In some implementations, the received communication frame may be identified as a broadcast or multicast frame if its PHY header indicates a transmit opportunity (TXOP) duration of zero. In some other implementations, the received communication frame may be identified as a broadcast or multicast frame if its PHY header includes a UL Flag value of zero (indicating a downlink transmission) and a BSS Color value of zero. Still further, in some implementations, the received communication frame may be identified as a broadcast or multicast frame if its PHY header includes a unique address that is associated with multiple recipients.

If the received communication frame is not a broadcast or multicast frame (as tested at 1230), the STA may discard the communication frame at the PHY (1240) and enter a power save mode for at least the duration of the communication frame (1250). It is noted that, the STA is unlikely to receive an incoming communication frame from an AP while the AP is transmitting a unicast frame to another STA. Moreover, by distinguishing unicast frames from broadcast or multicast frames at the PHY (instead of the MAC), the STA may quickly discard unicast frames intended for other STAs and enter a power save mode for the remainder of the unicast transmission. This may maximize the power savings of the STA.

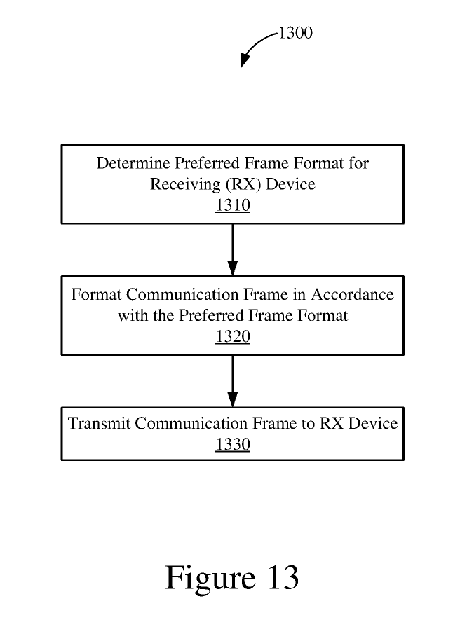

FIG. 13 shows a flowchart depicting an example operation 1300 for transmitting communication frames in accordance with a preferred frame format of a receiving device. The operation 1300 may be performed by an AP capable of implementing multiple PHY formats such as, for example, the AP 110 of FIG. 1, the AP 310 of FIG. 3, and the AP 610 of FIG. 6. With reference for example to FIG. 6, the operation 1300 may be performed by an HE AP (such as AP 610) to format unicast frames in accordance with the preferred frame format of the recipient STA.

The AP may determine a preferred frame format for a receiving (RX) device (1310). For example, the preferred frame format may be based at least in part on a proximity of the RX device to the AP or one or more channel conditions of a wireless channel between the RX device and the AP. In some implementations, the RX device may indicate its preferred frame format to the AP via a trigger frame. For example, the preferred frame format may be provided as a field in the HE Capabilities element or HE Operation element of one or more frames exchanged between the AP and the RX device during an association procedure. In some implementations, the RX device may dynamically adjust its preferred frame format. For example, the RX device may change its preferred frame format based on movements of the RX device, movements of the TX device, or changes in the channel conditions. Thus, in some aspects, the trigger frame may be a QoS Null (or Data) frame including an OMI A-Control field indicating a change to the preferred frame format.

The AP may format a communication frame in accordance with the preferred frame format of the RX device (1320), and transmits the communication frame to the RX device (1330). In some aspects, the AP may transmit broadcast and multicast frames using multiple PHY formats to ensure that each of the plurality of intended recipients (which may include legacy STAs and HE STAs with different preferred frame formats) is able to receive the broadcast or multicast information. Thus, if the communication frame includes broadcast or multicast information, the AP may ensure that at least one copy of the communication frame is formatted in accordance with the preferred frame format of the RX device. In some other aspects, the AP may transmit unicast frames in only one of the multiple PHY formats. Thus, if the communication frame includes unicast information intended for the particular RX device, the AP may format the communication frame in accordance with the preferred frame format of the RX device only.

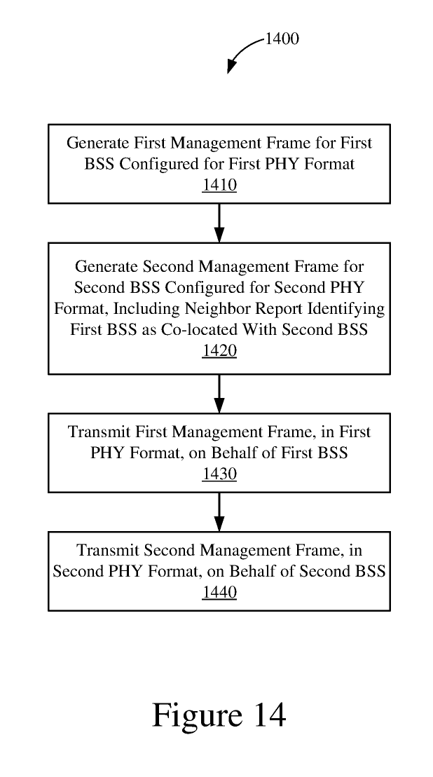

FIG. 14 shows a flowchart depicting an example operation 1400 for transmitting communication frames in accordance with multiple PHY formats. The operation 1400 may be performed by an HE AP capable of implementing multiple PHY formats such as, for example, the AP 110 of FIG. 1 or the AP 810 of FIGS. 8A and 8B. With reference for example to FIG. 8A, the operation 1400 may be performed by an AP hosting multiple BSSIDs (such as AP 810) to provide support for legacy STAs and HE STAs having different preferred frame formats.

The AP may generate a first management frame for a first BSS that is configured to support a first PHY format (1410). The first management frame may be a beacon frame, a probe response frame, or other management frame. As described with respect to FIGS. 8A and 8B, the AP may be configured to serve as a plurality of virtual BSSs. In some implementations, the AP may support a plurality of different PHY formats via the different virtual BSSs. For example, the first BSS may be a virtual BSS that is configured to format communication frames in accordance with a single PHY format (such as the ER format or the non-ER format). Accordingly, other virtual BSSs associated with the AP may be configured to support different PHY formats than that of the first BSS.

The AP also may generate a second management frame for a second BSS that is configured to support a second PHY format, where the second management frame includes a neighbor report identifying the first BSS as co-located with the second BSS (1420). For example, the second BSS may be a virtual BSS that is configured to format communication frames in accordance with a single PHY format that is different than the PHY format of the first BSS. The neighbor report may indicate the presence, locations, and capabilities of other BSSs (such as the first BSS) in the vicinity of the second BSS. In some implementations, the neighbor report may include one or more bits of information indicating the PHY format supported by the first BSS (such as whether the first BSS is configured for the ER or non-ER format) and an additional bit of information indicating that the first BSS is a co-located BSS (sharing the same physical location or one or more hardware components with the second BSS). For example, the additional bit of information indicating whether the first BSS is a co-located BSS may correspond to a co-located BSS (CL_BSS) indicator.

The AP may transmit the first management frame on behalf of the first BSS (1430), and may further transmit the second management frame on behalf of the second BSS (1440). More specifically, the first management frame may be formatted in accordance with the first PHY format and the second management frame may be formatted in accordance with the second PHY format. The co-located BSS indicator included in the second management frame may allow an associated HE STA to dynamically switch its association from the second BSS to the first BSS (such as described with respect to FIG. 8B). More specifically, the HE STA may dynamically switch between the first BSS and the second BSS based on its preferred frame format at any given time. For example, when the HE STA is within a standard wireless range of the AP, the STA may choose to associate with a virtual BSS (either the first BSS or the second BSS) that supports the non-ER format. However, when the STA moves beyond the standard wireless range of the AP, the STA may choose to reassociate with a different virtual BSS (the other of the first BSS or the second BSS) that supports the ER format.

As used herein, a phrase referring to “at least one of” a list of items refers to any combination of those items, including single members. As an example, “at least one of: a, b, or c” is intended to cover: a, b, c, a-b, a-c, b-c, and a-b-c.

The term “wireless station” or “STA,” as used herein, also may refer to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices such as, for example, a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method, comprising:
determining that a transmitting device is capable of formatting communication frames in accordance with a plurality of physical layer (PHY) formats;
selecting one of the plurality of PHY formats as a preferred frame format for a wireless device; and
selectively acquiring a first communication frame, from the transmitting device, based at least in part on the preferred frame format of the wireless device.

2. The method of claim 1, wherein at least one of the plurality of PHY formats is an extended range (ER) format.

3. The method of claim 1, wherein the selecting comprises:
selecting one of the plurality of PHY formats as the preferred frame format based at least in part on a proximity of the wireless device to the transmitting device or one or more channel conditions of a wireless channel between the wireless device and the transmitting device.

4. The method of claim 1, wherein the selectively acquiring comprises:
receiving the first communication frame at a PHY of the wireless device; and
selectively forwarding the first communication frame from the PHY to a media access control layer (MAC) based at least in part on whether the first communication frame is formatted in accordance with the preferred frame format.

5. The method of claim 4, wherein the selectively forwarding comprises:
forwarding the first communication frame from the PHY to the MAC only when the first communication frame is formatted in accordance with the preferred frame format.

6. The method of claim 4, further comprising:
determining, at the PHY, whether the first communication frame is at least one of a broadcast frame or a multicast frame.

7. The method of claim 6, wherein the first communication frame is determined to be at least one of a broadcast frame or a multicast frame when a PHY header of the first communication frame indicates a transmit opportunity (TXOP) duration of zero.

8. The method of claim 6, wherein the first communication frame is determined to be at least one of a broadcast frame or a multicast frame when a PHY header of the first communication frame indicates a downlink transmission from the transmitting device and includes a basic service set (BSS) color value of zero.

9. The method of claim 6, wherein the first communication frame is determined to be at least one of a broadcast frame or a multicast frame when a PHY header of the first communication frame includes a unique address associated with multiple recipients.

10. The method of claim 6, wherein the selectively forwarding comprises:
discarding the first communication frame, at the PHY, when the first communication frame is at least one of a broadcast frame or a multicast frame and is not formatted in accordance with the preferred frame format.

11. The method of claim 6, further comprising:
entering a power save mode for a duration of the first communication frame when the first communication frame is neither a broadcast frame nor a multicast frame and is not formatted in accordance with the preferred frame format.

12. The method of claim 1, wherein the selectively acquiring comprises:
transmitting, to the transmitting device, a second communication frame indicating the preferred frame format of the wireless device, wherein the indication is provided in at least one of a high efficiency (HE) capabilities element, an HE operation element, or an operating mode indication (OMI) element of the second communication frame.

13. A wireless device, comprising:
one or more processors; and
a memory storing instructions that, when executed by the one or more processors, cause the wireless device to:
determine that a transmitting device is capable of formatting communication frames in accordance with a plurality of physical layer (PHY) formats;
select one of the plurality of PHY formats as a preferred frame format for the wireless device; and
selectively acquire a first communication frame, from the transmitting device, based at least in part on the preferred frame format.

14. The wireless device of claim 13, wherein execution of the instructions for selecting the preferred frame format causes the wireless device to:
select one of the plurality of PHY formats as the preferred frame format based at least in part on a proximity of the wireless device to the transmitting device or one or more channel conditions of a wireless channel between the wireless device and the transmitting device.

15. The wireless device of claim 13, wherein execution of the instructions for selectively acquiring the first communication frame causes the wireless device to:
receive the first communication frame at a PHY of the wireless device; and
selectively forward the first communication frame from the PHY to a media access control layer (MAC) based at least in part on whether the first communication frame is formatted in accordance with the preferred frame format.

16. The wireless device of claim 15, wherein execution of the instructions for selectively forwarding the first communication frame from the PHY to the MAC causes the wireless device to:
forward the first communication frame from the PHY to the MAC only when the first communication frame is formatted in accordance with the preferred frame format.

17. The wireless device of claim 15, wherein execution of the instructions further causes the wireless device to:
determine, at the PHY, whether the first communication frame is at least one of a broadcast frame or a multicast frame; and
enter a power save mode for a duration of the first communication frame when the first communication frame is neither a broadcast frame nor a multicast frame and is not formatted in accordance with the preferred frame format

18. The wireless device of claim 17, wherein the first communication frame is determined to be at least one of a broadcast frame or a multicast frame when a PHY header of the first communication frame indicates a transmit opportunity (TXOP) duration of zero.

19. The wireless device of claim 17, wherein the first communication frame is determined to be at least one of a broadcast frame or a multicast frame when a PHY header of the first communication frame indicates a downlink transmission from the transmitting device and includes a basic service set (BSS) color value of zero.

20. The wireless device of claim 17, wherein the first communication frame is determined to be at least one of a broadcast frame or a multicast frame when a PHY header of the first communication frame includes an address associated with multiple recipients.

21. The wireless device of claim 17, wherein execution of the instructions for selecting forwarding the first communication frame causes the wireless device to:
discard the first communication frame, at the PHY, when the first communication frame is at least one of a broadcast frame or a multicast frame and is not formatted in accordance with the preferred frame format.

22. The wireless device of claim 13, wherein execution of the instructions for selectively acquiring the first communication frame causes the wireless device to:
transmit, to the transmitting device, a second communication frame indicating the preferred frame format of the wireless device, wherein the indication is provided in at least one of a high efficiency (HE) capabilities element, an HE operation element, or an operating mode indication (OMI) element of the second communication frame.

23. A method, comprising:
generating a first management frame for a first basic service set (BSS) configured for a first physical layer (PHY) format;
generating a second management frame for a second BSS configured for a second PHY format, wherein the second management frame includes a neighbor report identifying the first BSS as being co-located with the second BSS;
transmitting the first management frame, in the first PHY format, on behalf of the first BSS; and
transmitting the second management frame, in the second PHY format, on behalf of the second BSS.

24. The method of claim 23, wherein at least one of the first or second PHY formats is an extended range (ER) format.

25. The method of claim 23, wherein the neighbor report further indicates the PHY format of the first BSS.

26. The method of claim 23, further comprising:
receiving a reassociation request, from a wireless station (STA) associated with the second BSS, to reassociate with the first BSS, wherein the reassociation request is based at least in part on a preferred frame format of the STA.

27. The method of claim 23, wherein the first management frame further includes a neighbor report identifying the second BSS as being co-located with the first BSS

28. A wireless device, comprising:
one or more processors; and
a memory storing instructions that, when executed by the one or more processors, cause the wireless device to:
generate a first management frame for a first basic service set (BSS) configured for a first physical layer (PHY) format;
generate a second management frame for a second BSS configured for a second PHY format, wherein the second management frame includes a neighbor report identifying the first BSS as being co-located with the second BSS;
transmit the first management frame, in the first PHY format, on behalf of the first BSS; and
transmit the second management frame, in the second PHY format, on behalf of the second BSS.

29. The wireless device of claim 28, wherein the neighbor report further indicates the PHY format of the first BSS.

30. The wireless device of claim 28, wherein execution of the instructions further causes the wireless device to:
receive a reassociation request, from a wireless station (STA) associated with the second BSS, to reassociate with the first BSS, wherein the reassociation request is based at least in part on a preferred frame format of the STA.
